(19) United States
(12) Patent Application Publication
(10) Pub. No.: US 2009/0040340 A1
(43) Pub. Date: Feb. 12, 2009

(54) IMAGE MANAGEMENT APPARATUS, IMAGE MANAGEMENT METHOD, AND RECORDING MEDIUM RECORDING PROGRAM

(75) Inventors: Yuichi Nakase, Tokyo (JP); Yousuke Takagi, Tokyo (JP); Yasuyuki Ogawa, Tokyo (JP); Koji Hatanaka, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/187,288

(22) Filed: Aug. 6, 2008

(30) Foreign Application Priority Data
Aug. 10, 2007 (JP) 2007-208731

(51) Int. Cl. H04N 5/76; G06F 7/06; G06F 17/30

(52) U.S. Cl. 348/231.3; 707/5; 707/E17.029; 707/E17.014

(57) ABSTRACT

An image management apparatus includes: a narrowing-down reproduction unit for reproducing an image having particular attribute information; an attribute modification unit for modifying attribute information of the image under narrowing-down reproduction; an attribute modified image information storing unit configured to store information indicating the image which no longer contains the particular attribute information because of the modification performed on the attribute information by the attribute modification unit; and a control unit for performing control so as to regard the image indicated with the information stored in the attribute modified image information storing unit as a narrowing-down reproduction target image during the same narrowing-down reproduction as that at the time of modifying the attributes by said attribute modification unit, thereby enabling browsing of images including an image of which the attributes have been modified in a narrowing-down state, using a smaller storage area.

### BACKGROUND OF THE INVENTION

1. Field of the Invention

The present invention relates to an image management apparatus, image management method, and a recording medium recording a program, which perform browsing and management of image data.

2. Description of the Related Art

Nowadays, digital cameras have come into widespread use, and images shot by digital cameras, with images captured with personal computers (hereafter, referred to as “PC”) or the like are recorded in various types of recording media by a recording device, such as a digital camera, PC, or the like. The images recorded in a recording medium are reproduced by various types of image reproduction apparatuses, such as a digital camera, PC, or the like, for browsing, editing, and filing. In recent years, capacity of recording media has increased, allowing a great number of images to be saved, and accordingly, there has been a need to provide an image reproduction screen whereby target images can be browsed effectively.

For example, as such a technique, Japanese Patent Laid-Open No. 2005-33711 has proposed an image display device which holds a list correlating an image with the category attributes of the image, whereby image files classified into categories can be displayed in a list form for each category. With Japanese Patent Laid-Open No. 2005-33711, another category attribute can be added to the images displayed in a list form for each category.

Note however, the image display device described in Japanese Patent Laid-Open No. 2005-33711 holds an image list by category attribute, and accordingly, occupies a large storage area on the system at the time of implementation. Also, study has not been carried out regarding a management method of an image of which the attributes have been modified during display of a list of only the images belonging to a particular category (in a narrowing-down state), and consequently, has not belonged to the category which is a narrowed-down condition.

### SUMMARY OF THE INVENTION

The present invention provides for suitably performing the management of images excluded from narrowing-down conditions in a narrowing-down state, with a smaller storage area used.

According to the present invention, there is provided an image management apparatus including: a narrowing-down reproduction unit configured to reproduce an image having particular attribute information; an attribute modification unit configured to modify attribute information of the image reproduced by the narrowing-down reproduction unit; an attribute modified image information storing unit configured to store information indicating the image which no longer contains the particular attribute information because of the modification performed on the attribute information by the attribute modification unit; and a control unit configured to perform control so as to regard the image indicated with the information stored in the attribute modified image information storing unit as a target image to be reproduced by the narrowing-down reproduction unit, by referencing the information stored in the attribute modified image information storing unit from the time of modifying the attribute information by the attribute modification unit until reproduction by the narrowing-down reproduction unit is cancelled.

According to the present invention, browsing of images including an image of which the attributes have been modified in a narrowing-down state can be carried out using a smaller storage area.

This summary of the invention does not necessarily describe all necessary features so that the invention may also be a sub-combination of these described features. Further features of the present invention will become apparent from the following description of exemplary embodiments with reference to the attached drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is an external view of a digital camera as an embodiment of the present invention.

FIG. 2 is a configuration block diagram of the digital camera as an embodiment of the present invention.

FIG. 3 is a flowchart illustrating overall operation of a digital camera.

FIG. 4A is a flowchart illustrating file management processing of the digital camera.

FIG. 4B is a flowchart illustrating image search processing of the digital camera.

FIG. 5 is a flowchart illustrating reproduction processing of the digital camera.

FIG. 6 is a flowchart illustrating search management processing of the digital camera.

FIG. 7 is a flowchart illustrating search management file generation processing of the digital camera.

FIG. 8 is a diagram illustrating a configuration example of a search management file.

FIG. 9 is a flowchart illustrating reproduction input waiting processing of reproduction processing.

FIG. 10 is a flowchart illustrating classification information setting processing of the digital camera.

FIG. 11 is a flowchart illustrating classification information attribute writing processing of the digital camera.

FIG. 12 is a diagram illustrating a display screen example at the time of the classification information setting processing of the digital camera.

FIG. 13 is a flowchart illustrating jump mode processing of the digital camera.

FIG. 14A is a diagram illustrating a jump mode display screen of the digital camera.

FIG. 14B is a diagram illustrating display at an information display portion at the time of the jump mode of the digital camera.

FIG. 15 is a flowchart illustrating narrowing-down reproduction mode processing of the digital camera.

FIG. 16 is a flowchart illustrating narrowing-down information display processing at the time of narrowing-down reproduction mode of the digital camera.

FIG. 17A is a diagram illustrating a screen display example during narrowing-down reproduction of the digital camera.

FIG. 17B is a diagram illustrating a screen display example at the time of performing classification information setting during narrowing-down reproduction of the digital camera.

FIG. 17C is a diagram illustrating a screen display example at the time of performing classification information setting during narrowing-down reproduction of the digital camera.

FIG. 18 is a flowchart illustrating attribute modified file management processing of the digital camera.

FIG. 19 is a flowchart illustrating image ID obtaining processing of the digital camera.

FIGS. 20A and 20B are diagrams illustrating a configuration example of an attribute modified file list.

### DESCRIPTION OF THE EMBODIMENTS

Description will be made in detail regarding embodiments for implementing the present invention with reference to the appended drawings. Note that the embodiment described below is an example for realizing the present invention, to be corrected or modified depending on the configuration of the apparatus to which the present invention is to be applied, or various types of conditions, and the present invention is not restricted to the following embodiment.

Description will be made below regarding an embodiment of the present invention with reference to the appended drawings. Note that with the embodiment described below, description will be made regarding a case wherein an image management apparatus and image management method according to the present invention are applied to an image capturing apparatus which is a digital camera capable of shooting of still images and moving images, as an example.

### Configuration of Digital Camera

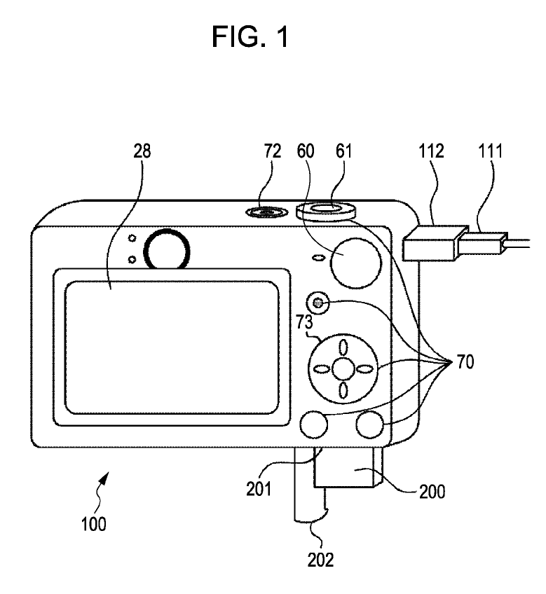

FIG. 1 is an external view of a digital camera according the present embodiment. In FIG. 1, reference numeral 28 denotes an image display unit, which displays an image and various types of information. Reference numeral 72 denotes a power supply switch, which switches power-on/power-off. Reference numeral 61 denotes a shutter button, and 60 denotes a mode changeover switch, which switches various types of mode at the digital camera 100. More specifically, changeover of a mode, such as still image recording mode, moving image recording mode, reproduction mode, or the like, can be performed. Reference numeral 111 denotes a connection cable, which connects the digital camera 100 and an external device. Reference numeral 112 denotes a connector, which connects the connection cable 111 and digital camera 100.

Reference numeral 70 denotes an operating unit, which accepts various types of operations from a user. The operating unit 70 includes various types of buttons shown in the drawing, and an operating member such as a touch panel provided on the screen of the image display portion 28. Specific examples of the various types of buttons of the operating unit 70 are a delete button, menu button, SET button, four direction buttons (upper button, lower button, right button, and left button) disposed crosswise, wheel 73, and so forth. Reference numeral 200 denotes a recording medium such as a memory card, hard disk or the like. Reference numeral 201 denotes a recording medium slot, which stores the recording medium 200. The recording medium 200 stored in the recording medium slot 201 can communicate with the digital camera 100. Reference numeral 202 denotes a lid of the recording medium slot 201.

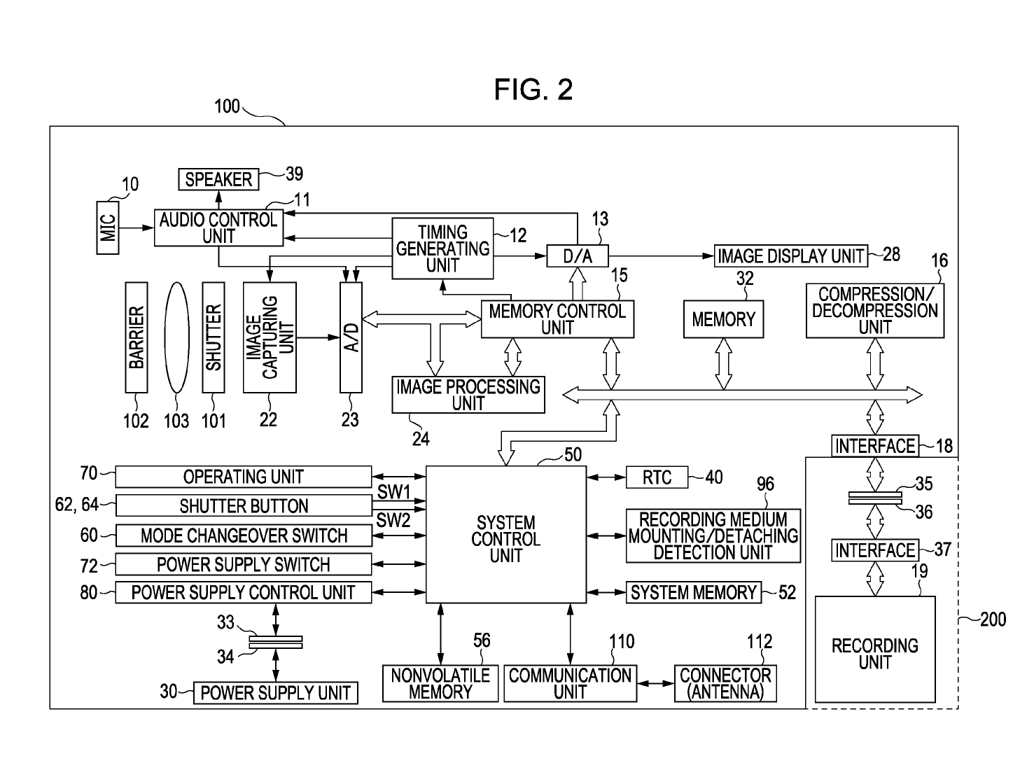

FIG. 2 is a block diagram illustrating a configuration example of the digital camera 100 according to the present embodiment. In FIG. 2, reference numeral 103 denotes a photography lens, 101 denotes a shutter having a diaphragm function, 22 denotes an image capturing unit configured of a CCD, CMOS device, or the like, for converting an optical image into an electric signal. Reference numeral 23 denotes an A/D converter, which converts an analog signal into a digital signal. The A/D converter 23 is employed in the case of converting the analog signal output from the image capturing unit 22 into a digital signal, or in the case of converting the analog signal output from an audio control unit 11 into a digital signal. Reference numeral 102 denotes a barrier, which covers the image capturing unit including the lens 103 of the digital camera 100, thereby preventing soiling and damage of an image capturing system including the photography lens 103, shutter 101, and image capturing unit 22.

Reference numeral 12 denotes a timing generating unit, which supplies a clock signal and control signal to the image capturing unit 22, audio control unit 11, A/D converter 23, and D/A converter 13. The timing generating unit 12 is controlled by a memory control unit 15 and system control unit 50. Reference numeral 24 denotes an image processing unit, which subjects the data from the A/D converter 23 or data from the memory control unit 15 to resizing processing such as predetermined pixel interpolation or reduction, or color conversion processing. Also, the image processing unit 24 performs predetermined calculation processing using captured image data, and based on the obtained calculation results the system control unit 50 performs exposure control and ranging control. Thus, AF (Auto Focus) processing employing the TTL (through-the-lens) method, AE (Automatic Exposure) processing, EF (pre-flash) processing are performed. Further, with the image processing unit 24, predetermined calculation processing is performed using captured image data, and based on the obtained calculation results AWB (Auto White Balance) processing employing the TTL method is also performed.

The output data from the A/D converter 23 is written in the memory 32 through the image processing unit 24 and memory control unit 15, or through the memory control unit 15 directly. The memory 32 stores image data obtained by the image capturing unit 22, and converted into digital data by the A/D converter 23, or image data to be displayed on the image display unit 28. Note that the memory 32 is also employed for storing a file header in the case of configuring audio data recorded at a microphone 10, a still image, moving image, and image file. Accordingly, the memory 32 has sufficient storage capacity necessary for storing a predetermined number of still images, certain period of time worth of a moving image, and audio.

A compression/decompression unit 16 compresses or decompresses image data using adaptation diffusion cosine transformation (ADCT) or the like. The compression/decompression unit 16 reads in the photographed image stored in the memory 32 with the shutter 101 as a trigger to perform compression processing, and writes the data subjected to the processing in the memory 32. Also, the compression/decompression unit 16 subjects the compressed image read in the memory 32 from the recording unit 19 of the recording medium 200 to decompression processing, and writes the data subjected to the processing in the memory 32. The image data written in the memory 32 by the compression/decompression unit 16 is subjected to filing at a file unit of the system control unit 50, and is recorded in the recording medium 200 through an interface 18. Also, the memory 32 also serves as memory (video memory) for image display). Reference numeral denotes a D/A converter, which converts the data for image display stored in the memory 32 into an analog signal to supply this to the image display unit 28. Reference numeral 28 denotes an image display unit, which performs display corresponding to the analog signal from the A/D converter 23 on a display such as an LCD or the like. The image data for display thus written in the memory 32 is displayed by the image display unit 28 through the D/A converter 13.

Reference numeral 10 denotes a microphone. The audio signal output from the microphone 10 is supplied to the A/D converter 23 through the audio control unit 11 configured of an amplifier and so forth, converted into a digital signal at the A/D converter 23, and then stored in the memory 32 by the memory control unit 15. On the other hand, the audio data recorded in the recording medium 200 is read in the memory 32, and then converted into an analog signal by the D/A converter 13. The audio control unit 11 drives the speaker 39 using this analog signal, and outputs the audio.

Nonvolatile memory 56 is electrically erasable and recordable memory, and for example, EEPROM or the like is employed as the nonvolatile memory 56. The nonvolatile memory 56 stores constants for operation of the system control unit 50, programs, and so forth. The programs mentioned here are programs for executing various types of flowcharts described later with the present embodiment.

Reference numeral 50 denotes a system control unit, which controls the entirety of the digital camera 100. The system control unit 50 executes the program recorded in the above-mentioned nonvolatile memory 56, thereby realizing later-described various processing of the present embodiment. Also, the system control unit 50 also performs the display control of the image display unit 28 through the memory 32, memory control unit 15, and D/A converter 13. Reference numeral 52 denotes system memory, and RAM is employed as the system memory. Constants for operation of the system control unit 50, variables, programs read out from the nonvolatile memory 56, and so forth, are loaded to the system memory 52.

The mode changeover switch 60, first shutter switch 62, second shutter switch 64, and operating unit 70 are operating units for inputting various types of operation instructions to the system control unit 50.

The mode changeover switch 60 can switch the operation mode of the system control unit 50 to any of the still image recording mode, moving image recording mode, reproduction mode, and so forth. The first shutter switch 62 is turned on in the middle of operation (half-pressing) of the shutter button 61 provided on the digital camera 100 to generate a first shutter switch signal SW1. In response to the first shutter switch signal SW1, the system control unit 50 starts operation such as AF (Auto Focus) processing, AE (Auto Exposure) processing, AWB (Auto White Balance) processing, EF (pre-flash) processing, or the like.

The second shutter switch 64 is turned on in the completion of operation (full-pressing) of the shutter button 61 to generate a second shutter switch signal SW2. In response to the second shutter switch signal SW2, the system control unit 50 starts operation of a series of shooting processing from reading out of a signal from the image capturing unit 22 up to writing of image data in the recording medium 200.

A function is assigned to each operating member of the operating unit 70 for each situation as appropriate by various function icons displayed on the image display unit 28 being selected and operated, and the respective operating members serve as various types of function buttons. Examples of the function buttons include an end button, return button, image feeding button, jump button, narrowing-down button, and attribute modifying button. For example, upon a menu button being pressed, a menu screen wherein various types of settings can be performed is displayed on the image display unit 28. The user can perform various types of settings intuitively using the menu screen displayed on the image display unit 28, four directions button, and SET button. The power supply switch 72 switches power supply on/off.

Reference numeral 80 denotes a power supply control switch, which is configured of a battery detection circuit, DC-DC converter, a switch circuit for switching a block to be turned on electrically, and so forth, and performs detection of mounting/dismounting of a battery, the type of battery, and remaining battery level. Also, the power supply control unit 80 controls the DC-DC converter based on the detection results thereof, and the instructions of the system control unit 50 to supply necessary voltage to the respective units including the recording medium 200 for necessary period of time.

Reference numeral 30 denotes a power supply unit, which is configured of a primary cell such as an alkaline battery, lithium cell, or the like, a secondary cell such as an NiCd battery, NiMH battery, Li battery, or the like, AC adapter, and so forth. Reference numerals 33 and 34 denote connectors, which connect the power supply unit 30 and power control unit 80.

Reference numeral 40 denotes a RTC (Real Time Clock), which tracks the date-and-time. The RTC 40 internally holds a power supply unit separately from the power supply control unit 80, and continues a counting state even when the power supply unit 30 is in a down state. The system control unit 50 sets a system timer using the date and time obtained from the RTC 40 at the time of start-up, and executes timer control.

Reference numeral 18 denotes an interface with the recording medium 200 such as a memory card, hard disk, or the like. Reference numeral 35 denotes a connector for connecting the recording medium 200 and interface 18. Reference numeral 96 denotes a recording medium mounting/detaching detection unit, which detects whether or not the recording medium 200 is mounted on the connector 35.

Reference numeral 200 denotes a recording medium such as a memory card, hard disk, or the like. The recording medium 200 includes a recording unit 19 configured of semiconductor memory, magnetic disk, or the like, an interface 37 with the digital camera 100, and a connector 36 for connecting the recording medium 200 and digital camera 100.

A communication unit 110 performs various types of communication processing such as RS232C, USB, IEEE1394, P1284, SCSI, modem, LAN, wireless communication, and so forth. The connector (antenna in the case of wireless communication) 112 connects the digital camera 100 to another equipment through the communication unit 110.

### Overall Operation of Digital Camera

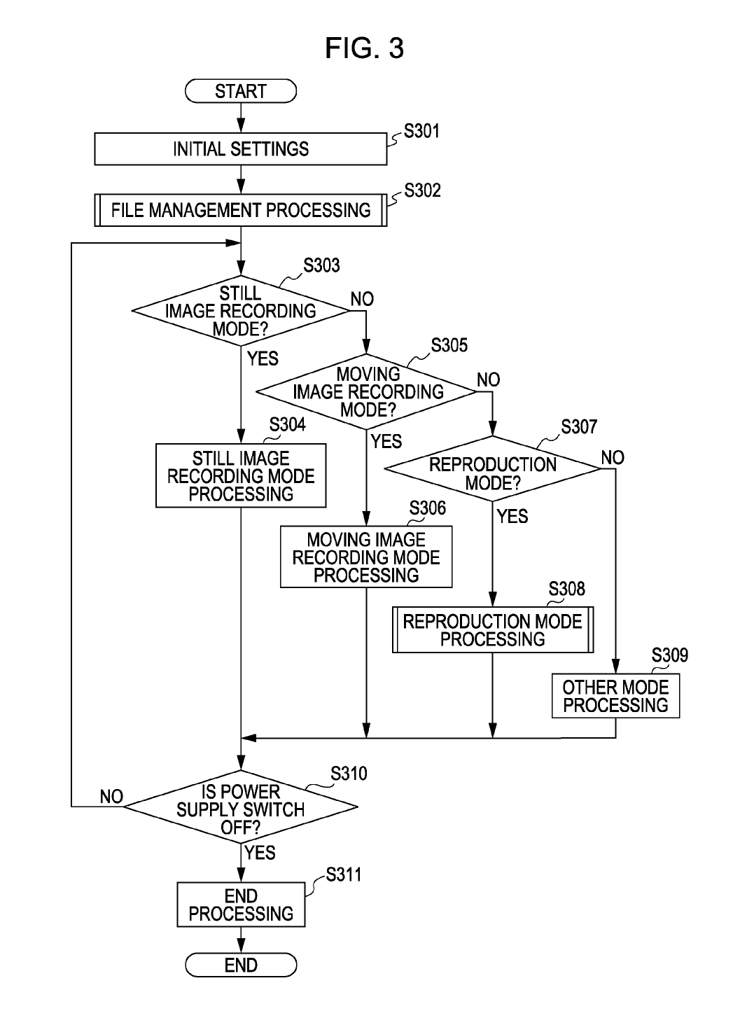

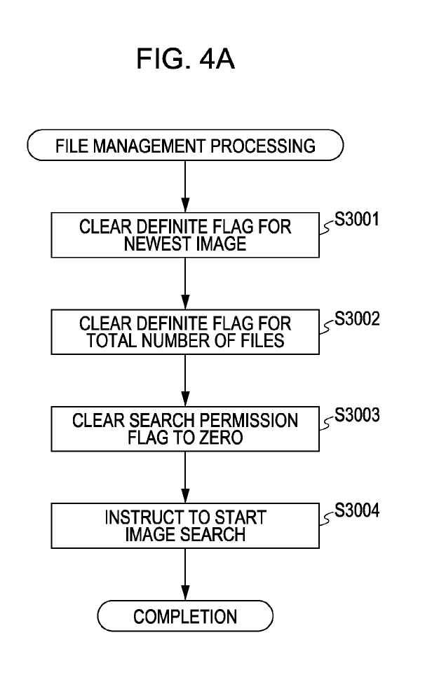

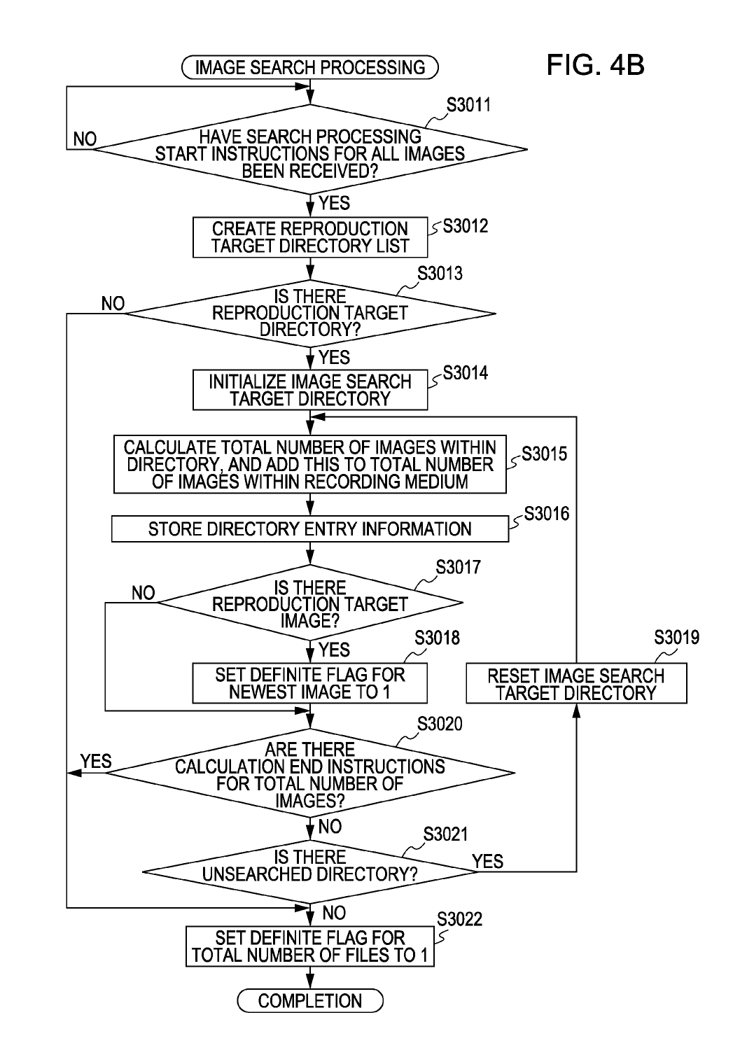

FIG. 3 is a flowchart for describing the overall operation of the digital camera 100 according to the present embodiment. Upon power supply being turned on by the power supply switch 72 being operated, in step S301 the system control unit 50 initializes a flag, control variable, and so forth. Subsequently, in step S302, the system control unit 50 starts management processing relating to files recorded in the recording medium 200. The file management processing in step S302 will be described later with reference to FIG. 4A.

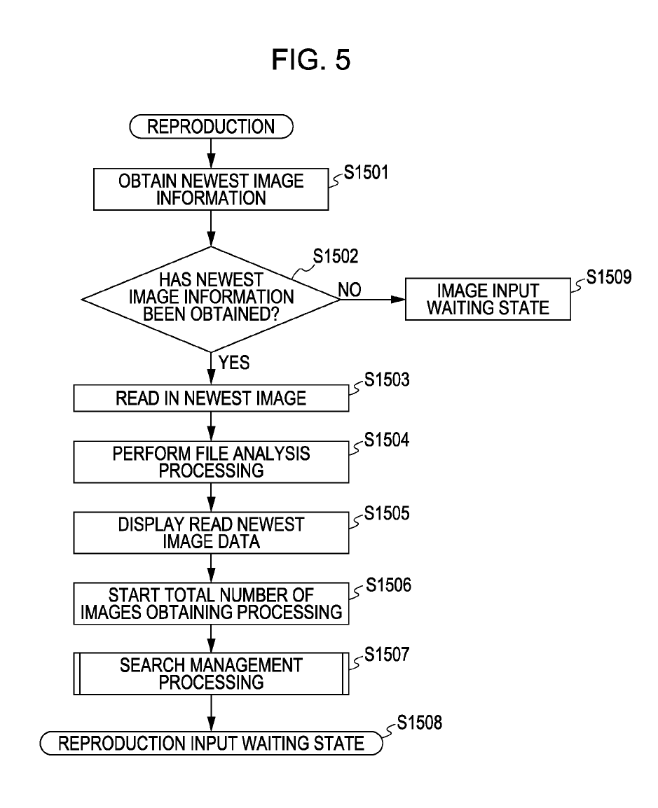

Next, in steps S303, S305, and S307, the system control unit 50 determines the setting position of the mode changeover switch 60. Upon the mode changeover switch 60 being set to the still image recording mode, the processing proceeds to step S304 from step S303, where the system control unit 50 executes still image recording mode processing. Upon the mode changeover switch 60 being set to the moving image recording mode, the processing proceeds to step S306 through steps S303 and S305, where the system control unit 50 executes moving image recording mode processing. Also, upon the mode changeover switch 60 being set to the reproduction mode, the processing proceeds to step S308 through steps S303, S305, and S307, where the system control unit 50 executes reproduction mode processing. The reproduction mode processing in step S308 will be described later with reference to FIG. 5.

Also, upon the mode changeover switch 60 being set to other modes, the processing proceeds to step S309, where the system control unit 50 executes the processing corresponding to the selected mode. Examples of the other modes include transmission mode processing for performing transmission of a file stored in the recording medium 200, and reception mode processing for receiving a file from an external device to store this in the recording medium 200. Following the processing corresponding to the mode set by the mode changeover switch 60 being executed of steps S304, S306, S308, and S309, the processing proceeds to step S310. In step S310, the system control unit 50 determines the setting position of the power supply switch 72. Upon the power supply switch 72 being set to power-on, the processing returns to step S303. On the other hand, upon the power supply switch 72 being set to power-off, the processing proceeds to S311 from S310, where the system control unit 50 performs end processing. The end processing includes, for example, the following processing. That is to say, the display of the image display unit 28 is changed to an end state, the lens barrier 102 is closed to protect the image capturing unit, parameters including flags, control variables, and so forth, setting values, and setting mode are recorded in the nonvolatile memory 56, and power supply to unnecessary portions is cut off. Upon the end processing in step S311 being completed, the present processing ends, and power supply is changed to an OFF state.

### File Management

FIG. 4A is a flowchart illustrating the image file management processing in step S302 shown in FIG. 3. The system control unit 50 clears a newest image determination flag recorded in the system memory 52 in step S3001, clears a total number of files determination flag in step S3002, and clears a search permission flag in step S3003. Also, in step S3004, the system control unit 50 outputs image search start instructions as to image search processing to be processed in parallel with the above-mentioned processing. The image search processing will be described later with reference to FIG. 4B. Subsequently, the present processing ends.

### Image Search Processing

FIG. 4B is a flowchart illustrating the image search processing to be executed in response to the image search start instructions in step S3004 shown in FIG. 4A. In response to the image search start instructions, the processing proceeds to step S3011 to step S3012. In step S3012, the system control unit 50 creates a reproduction target directory list. This is, for example, with a reproduction apparatus in accordance with the DCF standard, processing wherein the directory entries of the DCF root directory are analyzed to search DCF directories, and the searched directories are added to a reproduction target directory list. Subsequently, in step S3013, the system control unit 50 determines whether or not there is a reproduction target directory. In a case wherein determination is made that there is no reproduction target directory (i.e., in a case wherein there is no directory and no file that can be handled by the digital camera 100), the processing proceeds to step S3022. In step S3022, the system control unit 50 sets the total number of files to zero, sets the total number of files determination flag to 1, and the present processing ends.

On the other hand, in a case wherein determination is made that there is a reproduction target directory, in step S3014 the system control unit 50 initializes an image search target directory. With this initialization, for example, with a reproduction apparatus conforming to DCF standard, the DCF directory of the maximum number is set to the image search target directory. Next, in step S3015, the system control unit 50 calculates a total number of images within a directory set as an image search target by analyzing the directory entries of the relevant directory. Subsequently, the system control unit 50 adds the total number of images within the directory thereof to the total number of images within the recording medium 200.

In step S3016, the system control unit 50 obtains the file information described in directory entries of the DCF root directory. Specifically, the system control unit 50 obtains the minimum file number, maximum file number, sum of file numbers, sum of timestamps, sum of file sizes, total number of files, and so forth. Subsequently, the system control unit 50 stores these in the system memory 52 as directory entry information.

In step S3017, the system control unit 50 determines whether or not there is a reproduction target image file (i.e., file which the digital camera 100 can handle). In a case wherein determination is made that there is a reproduction target image, in step S3018 the system control unit 50 determines the newest image, and sets the newest image determination flag to 1. In a case wherein total number calculation end instructions have been received by the end button or the like being operated, the processing proceeds to step S3022 from step S3020, where the processing is interrupted, and the system control unit 50 leaves the image search processing.

Upon total number calculation end instructions having not been received, in step S3021 the system control unit 50 determines whether or not there is an unprocessed directory. In a case wherein determination is made that there is an unprocessed directory, in step S3019 the system control unit 50 sets the image search target directory to the unprocessed directory, and the processing returns to step S3015. Thus, the system control unit 50 subjects all of the directories described in the reproduction target directory list created in step S3012 to the above-mentioned processing in steps S3015 through S3018. Upon the processing in steps S3015 through S3018 being completed regarding all of the directories, the processing proceeds to step S3022. In step S3022, the system control unit 50 informs definition of the newest image, calculates the total number of images, sets the total number of files determination flag, and leaves the image search processing.

Note that in a case wherein even if there is a reproduction target directory, there is no reproduction target image within the directory thereof, let us say that the system control unit 50 sets the total number of images to zero, sets the total number of files determination flag, and leaves the image search processing.

### Reproduction Mode Processing

FIG. 5 is a flowchart for describing the operation of the reproduction mode of the digital camera 100 according to the present embodiment. The flowchart shown in FIG. 5 illustrates the details of step S308 shown in FIG. 3.

In step S1501, the system control unit 50 obtains the newest image information from the recording medium 200. Obtaining the newest image information prior to the calculation of total number of images, and creation of the search list provides an advantage wherein when entering the reproduction mode, the image display of such processing can be performed immediately. In step S1502, the system control unit 50 determines whether or not obtaining of the newest image information has been performed correctly in step S1501. In the case of the newest image information having not been obtained, the processing proceeds to step S1509. In step S1509, the system control unit 50 enters an image input standby state such that a message to the effect that there is no image is displayed on the image display unit 28 to inform the user of no image data. As for a case wherein the newest image information cannot be obtained, there can be conceived a state wherein there is no image at all, or a state wherein image information could not be obtained due to a media failure, or the like. If the newest image information can be obtained, determination is made that there is at least one image, and the processing proceeds to step S1503.

In step S1503, the system control unit 50 reads in the newest image data from the recording medium 200 based on the newest image information obtained in step S1501. Subsequently, in step S1504, the system control unit 50 performs file analysis processing, and obtains the photography information and attribute information and so forth of the image in the read newest image data. In step S1505, the system control unit 50 displays the read newest image data. Further, at this time the system control unit 50 displays the photography information and attribute information and so forth obtained in step S1504. Also, in accordance with the file analysis results in step S1504, if determination is made that the read image data is incorrect data, such as a part of the file being damaged, the system control unit 50 also displays an error display.

In step S1506, the system control unit 50 starts obtaining processing of the total number of images recorded in the recording medium 200. This processing in step S1506 operates at the background, whereby the system control unit 50 can proceed to the next processing without waiting for completion thereof.

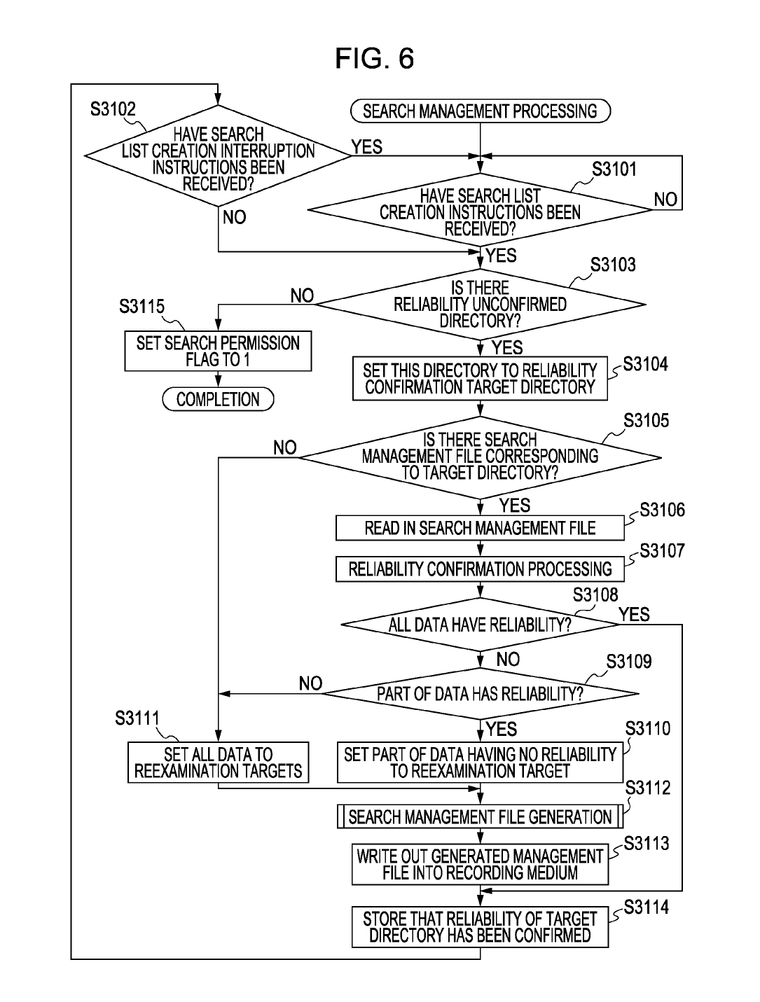

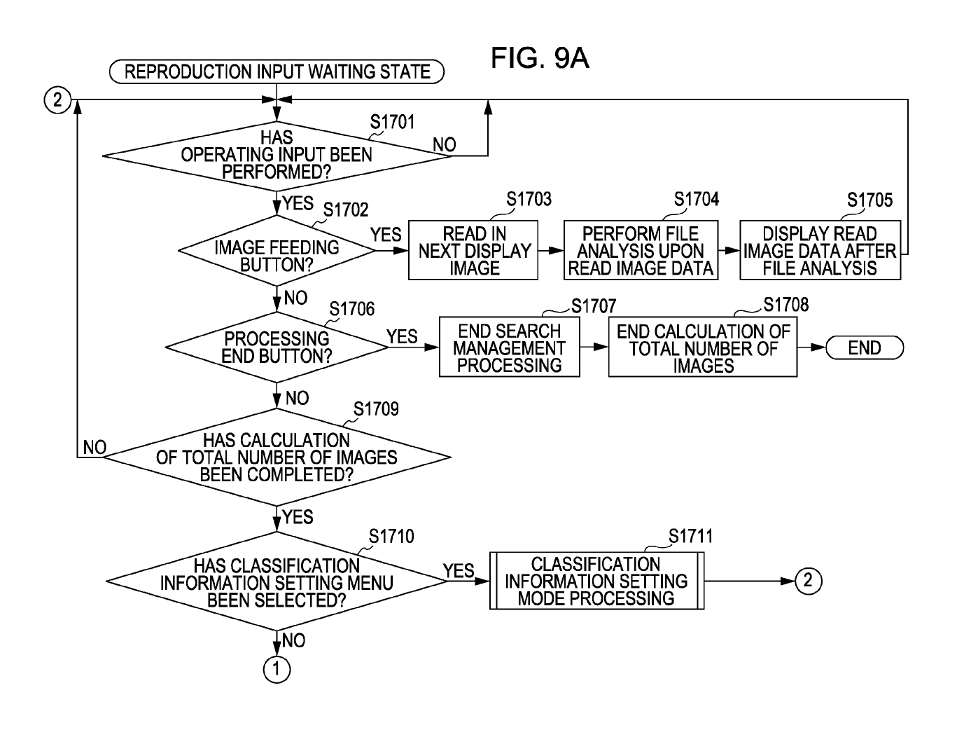

Next, in step S1507, the system control unit 50 performs search management processing to start creation of a search list. The search list mentioned here is a list for obtaining the attribute information appended to image data beforehand, and managing this. Creating a search list beforehand enables processing such as reproduction or deletion for each attribute to be performed rapidly. The search list creation processing is executed at the background in the same way as with the total number calculation, whereby the system control unit 50 can proceed to the next processing without waiting for completion thereof. This search management processing will be described later with reference to the flowchart shown in FIG. 6. In step S1508, the system control unit 50 enters an input standby state. The processing in this input standby state will be described later with reference to the flowchart shown in FIG. 9.

### Search Management System

FIG. 6 is a flowchart illustrating the flow of the search management processing in step S1507 shown in FIG. 5. Upon search list creation instructions being received in step S1507, the processing proceeds to step S3103 from step S3101. In step S3103, the system control unit 50 determines whether or not there is a directory of which reliability has not been confirmed. Upon reliability having been confirmed regarding all of the reproduction target directories, the processing proceeds to step S3115 from step S3103, where the system control unit 50 sets search permission flag=1 to the system memory 52, and ends the search management processing.

On the other hand, in a case wherein determination is made in step S3103 that there is a directory of which reliability has not been confirmed, in step S3104 the system control unit 50 sets the relevant directory to a target directory of which the reliability needs to be confirmed. Subsequently, in step S3105, the system control unit 50 determines whether or not there is the search management file corresponding to the target directory within the recording medium 200. In a case wherein determination is made that there is a search management file corresponding to the target directory, in step S3106 the system control unit 50 reads this search management file into the system memory 52. In step S3107, the system control unit 50 subjects the search management file read in step S3106 to confirmation of reliability. Specifically, confirmation of the reliability of the read search management file is performed by detecting modification of the configurations of the management target files, and modification of a management target file itself within the recording medium 200. Upon determination being made that all of the data have reliability as the confirmation results, the processing proceeds to step S3114 from step S3108, where the system control unit 50 performs processing for storing that the reliability of the target directory has been confirmed. Subsequently, the processing proceeds to step S3102, where the system control unit 50 confirms whether or not search list creation interruption instructions having been received.

On the other hand, as a result of the reliability confirmation processing in step S3107, in a case wherein determination is made in step S3108 that all of the data do not have reliability, and subsequently, determination is made in step S3109 that all of the data have no reliability, the processing proceeds to step S3111. Also, in a case wherein determination is made in step S3105 that there is no search management file as well, the processing proceeds to step S3111. In step S3111, the system control unit 50 regards all of the data within the directory as reexamination targets, and executes creation of a search management file in step S3112.

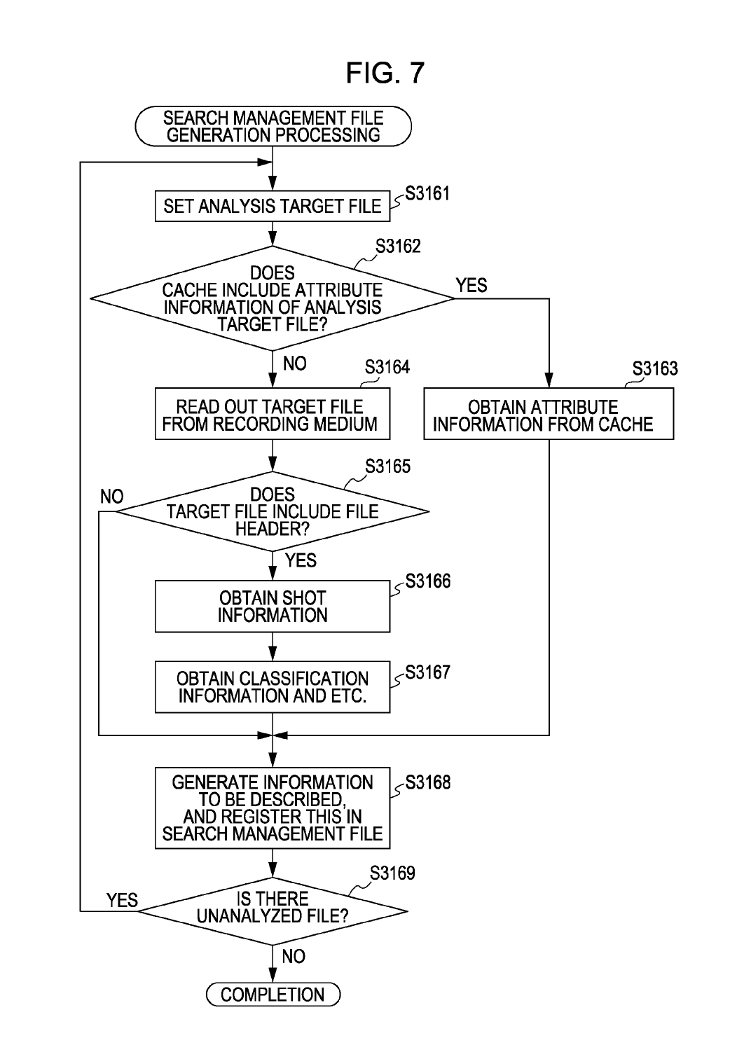

As a result of the reliability confirmation processing in step S3107, in a case wherein reliability has been confirmed regarding only a part of the data, the processing proceeds to step S3110 from step S3109. In step S3110, the system control unit 50 sets a par of the data of which reliability has not been confirmed as reexamination targets. Subsequently, in step S3112, the system control unit 50 performs creation of a search management file regarding the files to be set as the reexamination targets. The search management file creation processing will be described later with reference to FIG. 7.

Upon creation of a search management file in step S3112 being completed, in step S3113 the system control unit 50 writes the generated search management file to the recording medium 200. For example, a directory (XXXMSC) for storing a search management file is generated, and the generated search management file (e.g., M100.CTG, M101.CTG) is stored in the directory thereof. For example, M100.CTG is the search management file of a directory 100XXX, and M101.CTG is the search management file of a directory 101XXX. Subsequently, in step S3114, the system control unit 50 stores that the reliability of the directory has been confirmed in the system memory 52, and the processing proceeds to step S3102.

In a case wherein determination is made in step S3102 that the search list creation interruption instructions have been received, the processing returns to step S3101, where the system control unit 50 waits for search list creation instructions again. On the other hand, in a case wherein determination is made that the search list creation interruption instructions have not been received, the processing proceeds to step S3103, where the system control unit 50 continues the above-mentioned series of processing until there is no directory of which the reliability has not been confirmed. Subsequently, upon the processing having been completed regarding all of the reproduction target directories, the processing proceeds to step S3115 from step S3103, where the system control unit 50 set the search permission flag, and ends the search management processing.

### Creation of Search Management File

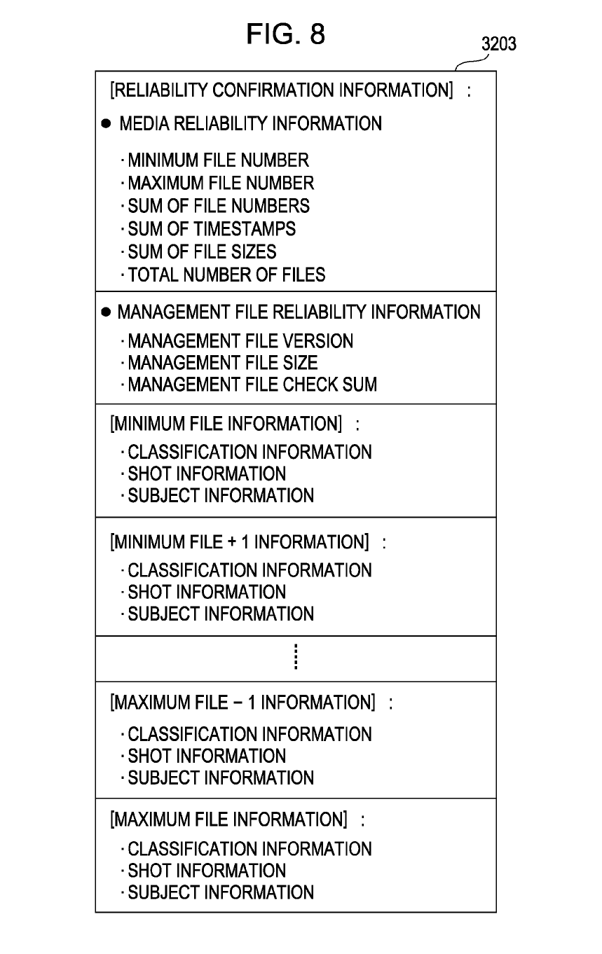

FIG. 7 is a flowchart illustrating the search management file creation processing in step S3112 shown in FIG. 6. The search management file creation processing will be described below with reference to the flowchart shown in FIG. 7 and the search management file shown in FIG. 8.

Upon the search management file creation processing being started, first in step S3161 the system control unit 50 performs the settings of an analysis file. This is a file unanalyzed with the present processing, of all files within the directory set by the above-mentioned search management processing (FIG. 6), or a part of the files of which the reliability has not been confirmed.

Next, in step S3162, the system control unit 50 determines whether or not there is the attribute information of the analysis target file in the cache area within the system memory 52. This cache information is held in the cache area of the system memory 52, for example, at the time of shooting of an image. In a case wherein determination is made that there is cache information, in step S3163 the system control unit 50 obtains information to be described in the search management file from the cache information, and in step S3168 generates and describe information to be described in the search management file. This information is file information such as shown in 3203 in FIG. 8, includes classification information, photography information, subject information, and so forth, and is stored in a correlated manner with information identifying the file. Note that a file name, file number, and so forth may be described in the list as information for identifying a file. Also, a file may be correlated with the list by the arrangement order of the list.

On the other hand, in a case wherein determination is made that there is no attribute information in the cache, the processing proceeds to step S3164. In step S3164, the system control unit 50 reads out the target file from the recording medium 200. Subsequently, in step S3165, the system control unit 50 determines whether or not the target file includes a file header of which the attribute information is described. In a case wherein determination is made that the target file includes a file header, in step S3166 the system control unit 50 obtains the photography information, and in step S3167 obtains the classification information and so forth. In step S3168, the system control unit 50 generates information to be described in the search management file, and describes this in the search management file.

On the other hand, in a case wherein determination is made in step S3165 that the target file includes no file header as well, in step S3168 the system control unit 50 describes information to the effect that the target file includes no file header in the management file.

Thus described above, the attribute information of the analysis file is registered in the management file in step S3168. Subsequently, in step S3169, the system control unit 50 confirms whether or not there is an unanalyzed file, and in a case wherein there is an unanalyzed file, the processing returns to step S3161, where the system control unit 50 sets the unanalyzed file to the analysis file, and repeats the above-mentioned processing. Upon the analysis regarding all of the requested files having been completed, the system control unit 50 ends the search management file creation processing.

Reproduction Input Waiting Processing (S1508) with Reproduction Mode Processing

FIG. 9 is a flowchart for describing processing in an input standby state with the reproduction mode processing. In step S1701, the system control unit 50 determines whether or not there has been operating input. The operating input mentioned here includes operations as to a button or battery lid by the user, an event for informing the user of reduction in power supply, and so forth. In the case of no operating input, the system control unit 50 awaits until there is operating input. In a case wherein there has been some sort of operating input, the processing proceeds to step S1702.

In step S1702, the system control unit 50 determines whether or not this operating input was input of the image feeding button included in the operating unit 70. In a case wherein the operating input was the image feeding button, the processing proceeds to step S1703, where the system control unit 50 reads in the next display image. The image feeding button is configured of a pair of buttons corresponding to the feeding direction, and the next display image is read in according to the feeding direction corresponding to the operated button. Next, in step S1704, the system control unit 50 subjects the image data read in step S1703 to file analysis processing such as photography information, attribute information, and so forth. Subsequently, in step S1705, the system control unit 50 displays the image data read in step S1703. At this time, the system control unit 50 displays the photography information, attribute information, and so forth using the results of the file analysis processing. Also, in a case wherein determination is made according to the file analysis results in step S1704 that the read image data is incorrect data, such as a part of the file being damaged, the system control unit 50 also displays error display. Upon display having been completed, the processing returns to the input standby state in step S1701.

In a case wherein determination is made in step S1702 that the input was not from the image feeding button, in step S1706 the system control unit 50 determines whether or not this operating input was from the end button. In a case wherein determination is made that the operating input was from the end button, the processing proceeds to step S1707, where the system control unit 50 ends the search management processing processed with the background in parallel since step S1507 shown in FIG. 5. In the case of a search list still being created, the control system 50 interrupts the creation processing thereof, and in the case of creation having been completed, performs nothing. Next, in step S1708, the system control unit 50 performs the end processing of the total number of images calculation processed with the background in parallel since step S1506 shown in FIG. 5. With this processing, in the same way as with the processing in step S1707, in the case of the total number of images calculation is still being calculated, the control system 50 interrupts the calculation processing thereof, and in the case of the calculation having been completed, performs nothing. Subsequently, the reproduction mode processing ends and the processing proceeds to step S310 shown in FIG. 3.

In a case wherein determination is made that the operating input is not from the end button, the processing proceeds to step S1709. In step S1709, the system control unit 50 determines whether or not the total number of images calculation processing started in step S1506 shown in FIG. 5 has been completed. Subsequently, in the case of the processing having not been completed, the processing returns to the operating input standby state in step S1701. At this time, it can also be conceived that a message or icon to the effect that the processing has not been completed is displayed. According to the above-mentioned processing, the image feeding operation by the image feeding button and the end operation by the end button are executed without waiting for the completion of calculation of the total number of images, but other operating input processing is ignored until the total number of images calculation processing is completed.

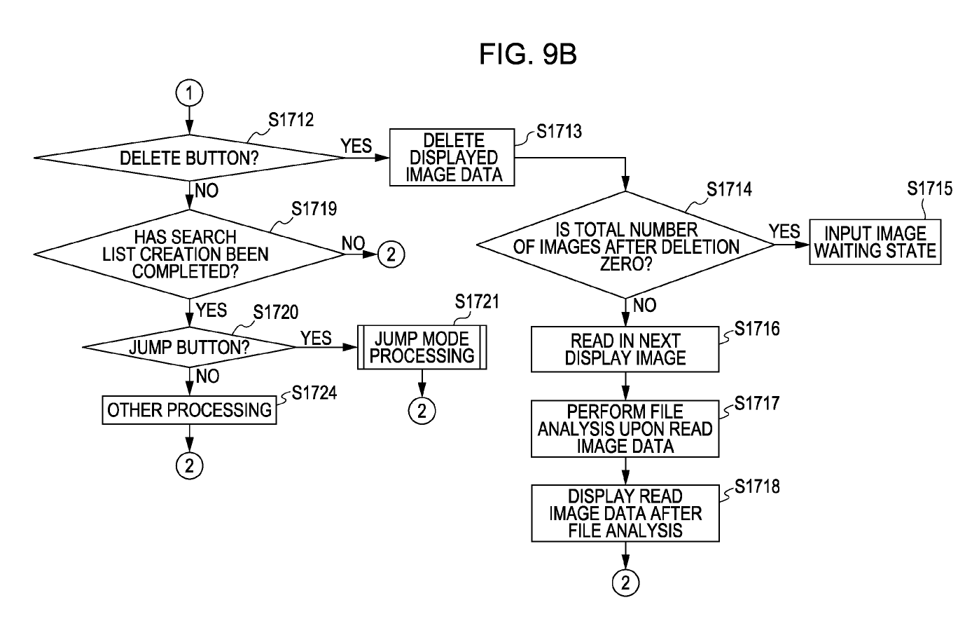

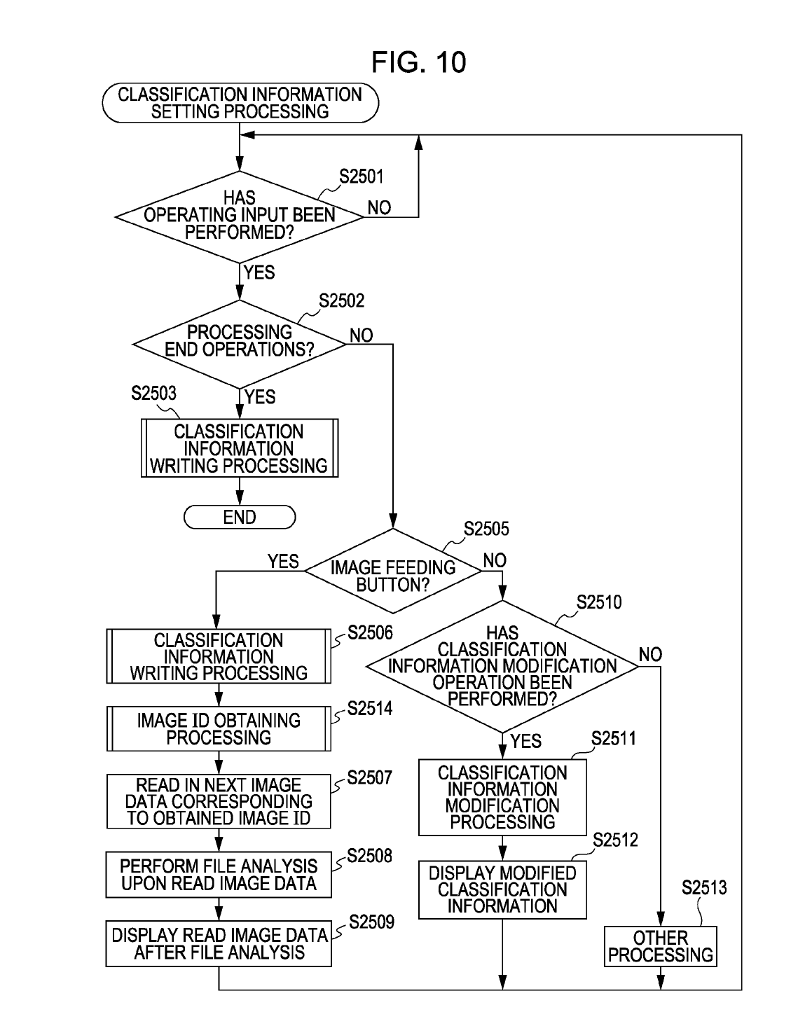

In a case wherein determination is made in step S1709 that the total number of images calculation has been completed, the processing proceeds to step S1710. In step S1710, the system control unit 50 determines whether or not a classification setting menu has been selected by the operations of the operating unit 70. In a case wherein determination is made that the classification setting menu has been selected, the processing proceeds to step S1711, where the system control unit 50 executes classification information setting mode processing. The classification information setting mode processing will be described later with reference to FIGS. 10, 11, and so forth. The classification information mentioned here is information added to an image as image attribute information, and is information suitable for image operations. Examples of this classification information include single or multiple information to be added automatically based on the parameters at the time of shooting, such as “person”, “scenery”, and “event”. Also, there are classification information such as “category 1”, “category 2”, and category 3”, which is added manually by the user, and classification information such as “for work” for prompting particular processing such as mail transmission or the like at the transfer destination at the time of transferring image data to an external device. Let us say that the classification information is automatically added by a device at the time of shooting or the like, or added by later-described predetermined user operations. In a case wherein determination is made that the classification setting menu has not been selected, the processing proceeds to step S1712.

In step S1712, the system control unit 50 determines whether or not the operating input was from the delete button included in the operating unit 70. In a case wherein determination is made that the operating input was from the delete button, the processing proceeds to step S1713. In step S1713, the system control unit 50 executes deletion of image data currently displayed on the image display unit 28. Upon deletion of the image data being completed, in step S1714 the system control unit 50 confirms the total number of images after deletion. In a case wherein the total number of images is zero, the processing proceeds to step S1715, where the system control unit 50 enters an image input standby state such that a message to the effect that there is no image is displayed on the image display unit 28 to inform the user of no image data. On the other hand, in a case wherein confirmation is made in step S1714 that image data remains after deletion, the processing proceeds to step S1716, where the system control unit 50 reads in image data to be displayed next to display the next image data. Now, let us say that the image data to be displayed is the image data having the next file number of the file number of the deleted image data. Note that in the case of the newest image data being deleted, the image data having a file number one step back of the file number of the deleted image data is taken as a display target. In step S1717, the system control unit 50 subjects the image data read in as a display target in step S1716 to file analysis processing, and obtains photography information, attribute information, and so forth. Subsequently, in step S1718, the system control unit 50 displays the image data read in step S1716 on the image display unit 28. At this time, the system control unit 50 also displays the photography information, attribute information, and so forth obtained in step S1717. In a case wherein determination is made according to the file analysis results in step S1717 that the read image data is incorrect data, such as a part of the file being damaged, the system control unit 50 also displays an error display to the effect that the read image data is incorrect data. Upon the display being completed, the processing returns to the operating input standby state in step S1701.

In a case wherein determination is made in step S1712 that the operating input was not the delete button, the processing proceeds to step S1719. In step S1719, the system control unit 50 determines whether or not the search management processing started in step S1507 shown in FIG. 5 has been completed. In the case of the search management processing having not been completed, the processing returns to the operating input standby state in step S1701. At this time, in the same way as with the above-mentioned case wherein the total number of images calculation has not been completed, a message or icon to the effect that the search list creation processing has not been completed may be displayed. According to the above-mentioned processing, the operating input processing other than the above-mentioned processing is ignored until the search management processing is completed. Now, the above-mentioned processing includes image feeding operation (S1702 through S1705), end operation (S1706 through S1708), execution of the classification information setting mode (S1710, S1711), and image deletion operation (S1712 through S1718).

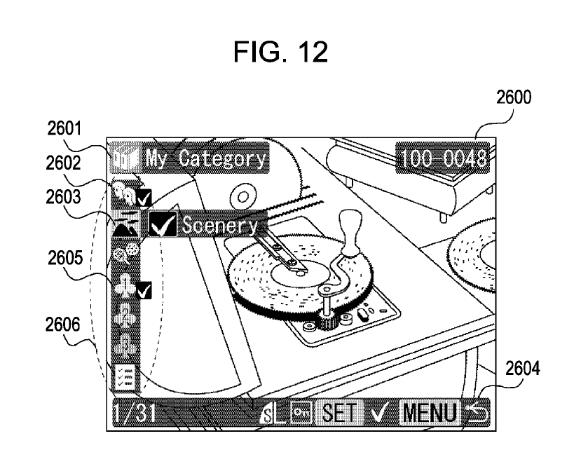

In a case wherein determination is made in step S1719 that the search list creation processing has been completed, the processing proceeds to step S1720. In step S1720, the system control unit 50 determines whether or not the operating input was jump instructions. In a case wherein determination is made that the operating input was jump instructions, the processing proceeds to the jump mode processing in step S1721. The jump mode processing will be described later with reference to FIG. 13 and so forth.

In a case wherein determination is made in step S1720 that the operating input was not jump instructions, the processing proceeds to step S1724. In step S1724, the system control unit 50 performs the processing corresponding to the operating input other than the above. Examples of this processing include switching to multiple reproduction, and menu display by a menu button. Note that the multiple reproductions mentioned here is a reproduction mode wherein multiple reduction images of image data are arranged and displayed on one screen of the image display unit 28.

### Classification Information Setting Mode

Description will be made regarding the processing according to the classification information setting mode described above in step S1711 shown in FIG. 9. FIG. 10 is a flowchart illustrating the classification information setting processing according to the classification information setting mode. Note that this processing is also executed in step S2319 of later-described narrowing-down reproduction mode processing.

Upon the classification information setting processing being started, first, in step S2501, the system control unit 50 determines whether or not there has been operating input. The operating input mentioned here includes operations as to a button or battery lid by the user, an event for informing the user of reduction in power supply, and so forth. In the case of no operating input, the system control unit 50 awaits until there is operating input. In a case wherein there has been some sort of operating input, the processing proceeds to step S2502.

In step S2502, the system control unit 50 determines whether or not there have been end operations for instructing the end of the classification information setting, and in the case of there have been the end operations, the processing proceeds to step S2503. Note that with the present embodiment, the operations for instructing the end of the classification information setting include operations for the menu button of the operating unit 70 to leave the classification information setting processing, operations for turning off power supply, mode change operations from the reproduction mode to the shooting mode, and so forth. In step S2503, the system control unit 50 performs classification information writing processing for writing the classification information of image data modified in step S2511 (later described) to an image file. This classification information writing processing will be described later with reference to FIG. 11. Following the classification information writing processing being performed, the classification information setting mode ends, and the processing returns to the input standby state (step S1701) shown in FIG. 9.

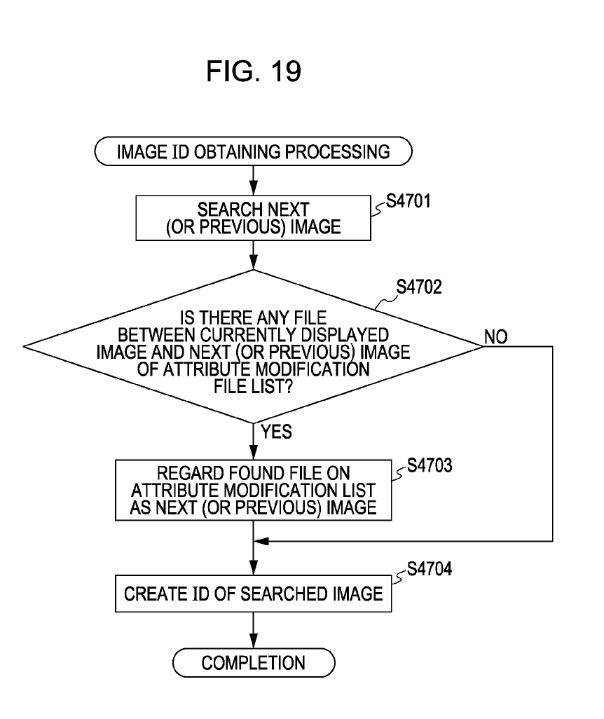

In step S2505, the system control unit 50 determines whether or not the operating input detected in step S2501 has been operations for the image feeding button included in the operating unit 70, and in a case wherein the operating input was the operations for the image feeding button, the processing proceeds to step S2506. In step S2506, the system control unit 50 performs classification information writing processing for writing the classification information of image data modified in step S2511 (later described) to an image file. This classification information writing processing will be described later with reference to FIG. 11. Next, in step S2514, the system control unit 50 obtains the ID of an image to be displayed next at image ID obtaining processing, and reads in the image data of the image corresponding to the ID obtained in step S2507. This image ID obtaining processing will be described later with reference to FIG. 19. The image feeding button is formed in a paired direction (left and right direction buttons in the present example), and image data to be displayed next changes depending on the instructed direction. In step S2508, the system control unit 50 subjects the image data read in step S2507 to file analysis processing, and obtains attribute information and so forth from the file. Subsequently, in step S2509, the system control unit 50 displays the image data read in on the image display unit 28. At this time, the system control unit 50 displays attribute information such as photography information, classification information, and so forth depending on the settings. Also, in a case wherein determination is made according to the file analysis results in step S2508 that the read image data is incorrect data, such as a part of the file being damaged, the system control unit 50 also displays error display to the effect that the read image data is incorrect data. Upon the display being completed, the processing returns to step S2501, where the system control unit 50 enters the operating input standby state.

Note that the image feeding processing described in steps S2505 through step S2509 can be applied to any case of single reproduction wherein a single image is displayed one screen, and multiple reproduction wherein multiple images (e.g., nine images) are reproduced on one screen (also referred to as multiple image display). In the case of the multiple image display, an arrangement is made wherein a cursor is moved sequentially according to image feeding instructions, and the classification information of image data is written to an image file according to the movement instructions thereof.

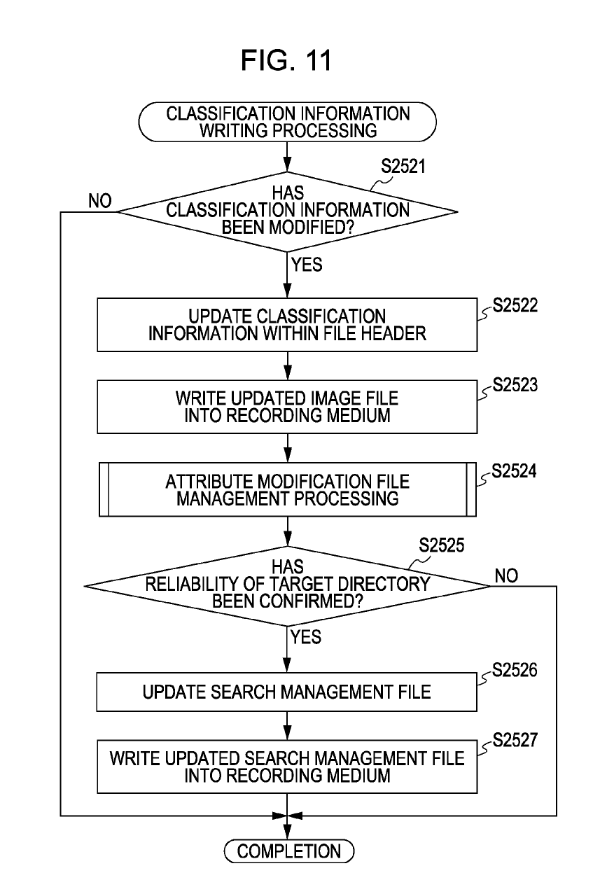

In step S2510, the system control unit 50 determines whether or not the operating unit detected in step S2501 has been classification information modification operations, and in a case wherein the operating unit detected in step S2501 has been classification information modification operations, the processing proceeds to step S2511. In step S2511, the system control unit 50 performs the classification information modification processing of the displayed image data. Note that with this stage, the modification of the classification information is not written in the image file, and the modification content is stored in the system memory 52. Subsequently, in step S2512, the system control unit 50 reflects the modified classification information upon the display on the image display unit 28. The classification information modification operations will be described later using the display example shown in FIG. 12.

In a case wherein the operating input detected in step S2501 does not correspond to any of the above, in step S2513 the system control unit 50 performs other processing. Examples of the other processing include switching between single reproduction and multiple image display.

As described above, writing of classification information to an image file is performed at the time of switching to image data display or at the time of end of the classification information setting mode, whereby the number of times of access to the recording medium 200 can be reduced, and accordingly, operation speed can be improved.

### Classification Information Writing Processing

FIG. 11 is a flowchart illustrating the classification information writing processing executed in steps S2503 and S2506 shown in FIG. 10. In response to a classification information writing request, in step S2521 the system control unit 50 determines whether or not the classification has been modified. In a case wherein determination is made that the classification has not been modified, the system control unit 50 ends the present processing. On the other hand, in a case wherein determination is made that the classification has been modified, the processing proceeds to step S2522.

In step S2522, the system control unit 50 records the classification information after the modification in the file header of the image file, and updates the classification information within the file header. Subsequently, in step S2523, the system control unit 50 writes the image file of which the file header has been updated in the recording medium 200.

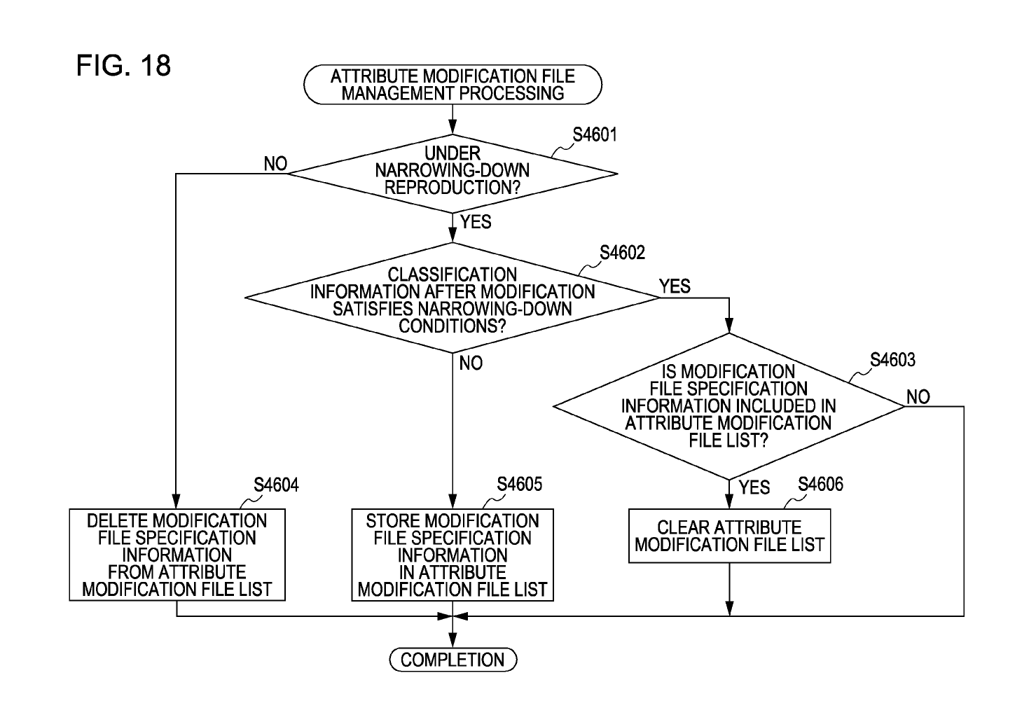

Subsequently, in step S2524, the system control unit 50 performs attribute modified file management processing. The attribute modified file management processing will be described later with reference to FIG. 18. Upon the attribute modified file management processing being completed, the processing proceeds to step S2525. In step S2525, the system control unit 50 determines whether or not reliability confirmation regarding the target directory described in step S3107 has been completed. In a case wherein reliability confirmation regarding the target directory has been completed, the processing proceeds to step S2526. The system control unit 50 updates the described content of the search management file. Subsequently, in step S2527, the system control unit 50 writes the updated search management file to the recording medium 200. On the other hand, in a case wherein reliability confirmation regarding the target directory has not been completed, the system control unit 50 skips steps S2526 and S2527, and ends the present processing without updating the search management file.

Classification Information Setting Screen

FIG. 12 is a diagram illustrating a display example of a classification information setting screen. In FIG. 12, reference numeral 2600 denotes the entirety of the classification information setting screen according to the present embodiment. According to operations from the classification information setting screen 2600, the classification information stored in a correlated manner with the image data currently displayed can be modified.

Reference numeral 2601 is title display indicating that the current screen is the classification information setting screen. Reference numeral 2606 is list display of settable classification information. With this display example, seven types of classification are displayed in a vertical list form. A check mark is indicated upon the classification display corresponding to classification information added to the image data being displayed. In FIG. 12, a check mark is displayed as to the classification display 2602 of “person” and the classification display 2605 of “category 1”. Accordingly, it can be found that the classification information of “person” and “category 1” are added to the image data displayed on the classification information setting screen 2600.

Reference numeral 2603 denotes classification information currently being changed. The background color is changed such that the cursor points thereto. Further, the checkmark thereof is displayed greater than those of other classifications. In this state, a SET button included in the operating unit 70 is pressed, thereby turning on/off classification information. Upon the above-mentioned operations being performed in a state wherein classification information to be modified is not added to the image data being displayed, a check mark is added to the relevant classification information by the SET button being pressed. On the other hand, upon the above-mentioned operations being performed in a state wherein classification information to be modified is added to the image data being displayed, the classification information is deleted from the image data by the SET button being pressed. The classification information to which a check mark is added in this screen is actually written in the image file at the time of image feeding or end operations, as described above with reference to FIG. 10.

Reference numeral 2604 is guidance display. This guidance display illustrates that a check mark can be added or deleted with the above-mentioned SET button, and the classification information setting mode can be ended with a MENU button. With this screen, the classification information serving as a modified target can be modified with the upper or lower button included in the operating unit 70. Also, the image data currently displayed can be switched with the left or right button through image feeding.

Based on the classification information thus added, later-described narrowing-down reproduction and so forth can be executed.

### Jump Mode Processing

Next, description will be made regarding jump processing according to the jump mode performed in step S1721 shown in FIG. 9. The jump processing mentioned here is processing for selecting particular attribute information, and switching image data to be displayed in increments of the attribute information thereof. In other words, this is processing for jumping to an image file having particular attribute information. Specific examples of attribute information serving as increments of jump (hereafter, referred to as “jump key”) include photography date, classification information, folder, moving image, etc. For example, with the jump processing in the case of photography date being taken as a jump key (hereafter, referred to as “date jump”), image data is classified into groups in increments of dates, e.g., such as Jan. 1, 2006, Jan. 2, 2006, and so on with photography date as reference. Subsequently, each time image feeding by the user operations is performed, image data representing each group is displayed one sheet at a time. That is to say, according to image feeding operations, jump is made to the representative image data of each photography date. Note that the jump key may not be based on the attribute information, and for example, may be selected in increments of the number of sheets, for example, such as “display in increments of 10 sheets”, or “display in increments of 100 sheets”.

Next, the flow of the jump processing will be described. FIG. 13 is a flowchart illustrating the processing in step S1721 shown in FIG. 9, which is executed by the user performing operations for changing to the jump mode.

Upon the jump processing being started, first, in step S1901, the system control unit 50 references the nonvolatile memory 56, and determines whether or not the jump key selected last time at the previous jump mode has been stored. The jump key stored in this nonvolatile memory 56 will be described later in step S1920. In a case wherein determination is made that the jump key has been stored, in step S1902 the system control unit 50 sets the jump key thereof as a first jump key. On the other hand, in a case wherein determination is made that the jump key has not been stored, in step S1903 the system control unit 50 takes a default jump key stored in the nonvolatile memory 56 as a first jump key.

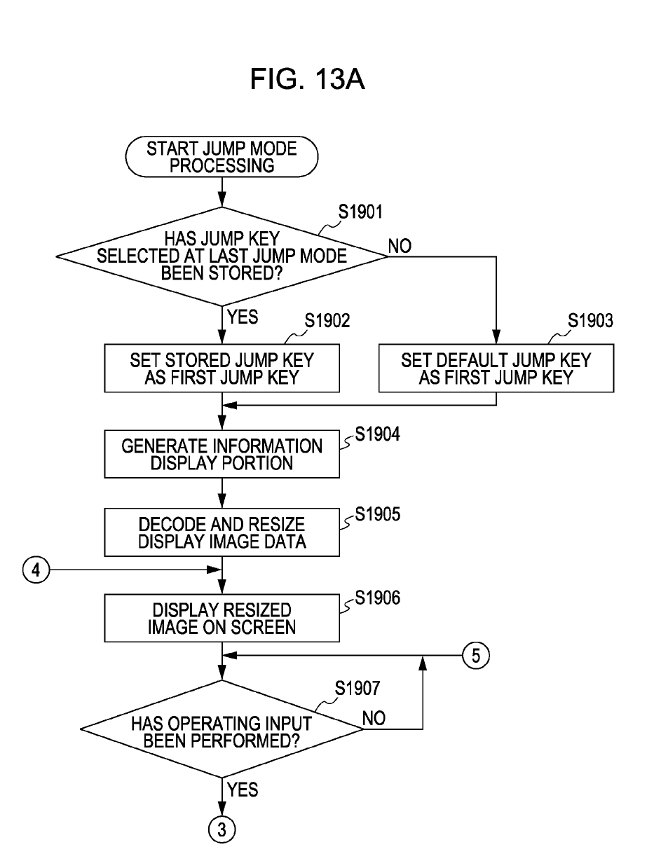

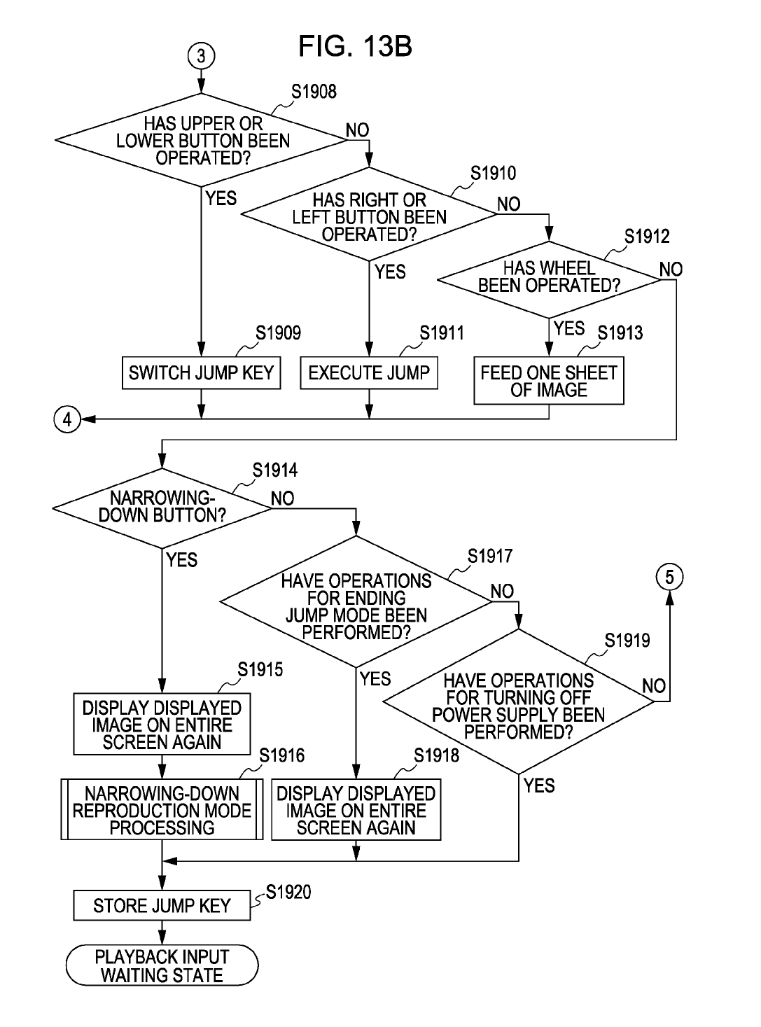

Next, in step S1904, the system control unit 50 generates an information display unit based on the selected jump key. Subsequently, in step S1905, the system control unit 50 decodes image data to be displayed, and resizes this to display with a size one step smaller than the size of the image display unit 28. Next, in step S1906, the system control unit 50 displays the resized image data, jump key list display 2001, the cursor of the selected jump key, and information display portion 2009 on the image display unit 28 (FIG. 14A).

Now, an example of a screen displayed on the image display unit 28 is shown in FIG. 14A. Reference numeral 2003 denotes an image display area for displaying image data as a current display target. Reference numeral 2001 denotes an area for displaying jump keys in a list form (jump key list display). An icon indicating various types of jump key is displayed within this area. Reference numeral 2008 is an icon indicating date jump. Reference numeral 2002 denotes an icon indicating jump processing with classification information as a jump key (hereafter, referred to as “classification jump”). Reference numeral 2004 denotes an icon indicating jump processing with a folder to which an image file belongs as a jump key (hereafter, referred to as “folder jump”). Reference numeral 2005 denotes an icon indicating jump processing with a moving image file as a jump key (hereafter, referred to as “moving image jump”). Reference numeral 2006 is an icon indicating that image feeding is performed in increments of 10 images. Reference numeral 2007 is an icon indicating that image feeding is performed in increments of 100 images. Of jump keys, the icon display of the jump key currently selected becomes in a state wherein the cursor points thereto. For example, in FIG. 14A, the icon 2002 is now selected. Upon the display in step S1906 shown in FIG. 13 being performed, the processing proceeds to step S1907, where the system control unit 50 enters a state waiting for the operating input from the user.

In a case wherein there have been operations from the user in step S1907, the processing proceeds to step S1908, where the system control unit 50 determines whether or not the key operated and input from the user has been the upper button or lower button. In a case wherein determination is made that the operated key has been either the upper or lower key, the processing proceeds to step S1909 from step S1908. In step S1909, the cursor of the jump key on the jump key list display 2001 is moved in the upper or lower direction. That is to say, the user operates the upper or lower button, whereby the jump key can be switched to a desired jump key. The jump key is moved to one step upper icon when the upper button has been pressed, or moved to one step lower icon when the lower button has been pressed.

In a case wherein the operating input detected in step S1907 has been the left or right button, the processing proceeds to step S1911 from step S1910.

In step S1911, the system control unit 50 performs group changeover processing in accordance with input of the left or right button (jump execution). FIG. 14B illustrates the details of the information display portion 2009 in FIG. 14A. In step S1911, for example, upon the right button being pressed in a state wherein the “category 1” 2017 is selected, the content of the image display area 2003 in FIG. 14A is switched to the content of an image file having the classification information of the “category 2” 2018. Also, similarly, upon the left button being pressed, display is switched to the display of an image file having the classification information of the “event” 2016. That is to say, the user operates the left or right button, whereby the group to be displayed can be switched to a desired group, and the jump processing can be executed. Upon the processing in step S1911 being completed, the processing returns to step S1906. In step S1906, the system control unit 50 displays the image resized in step S1967 on the image display unit 28. Thus, the display content of the image display area 2003 is updated to the image corresponding to the selected group. In a case wherein the operating input detected in step S1907 has been the operating input of the wheel 73, the processing proceeds to step S1913 from step S1912. In step S1913, the system control unit 50 performs image feeding by one image within the group where the cursor is positioned to display this.

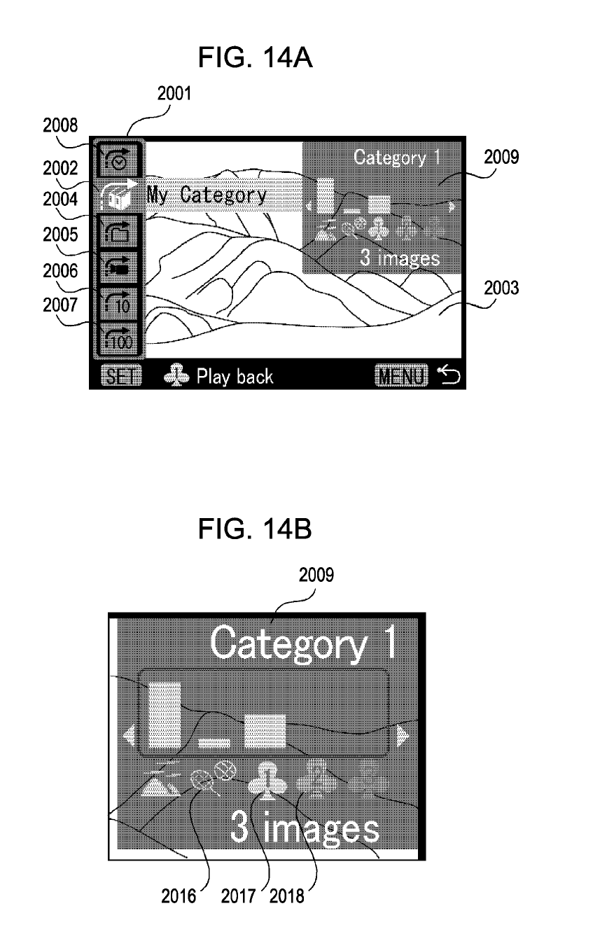

In a case wherein the operating input detected in step S1907 has been operations for narrowing-down display (operations of the narrowing-down button), the processing proceeds to step S1915 from step S1914. In step S1915, the system control unit 50 redraws (resizes) the image data being displayed on the image display area 2003 so as to display this on the entirety of the image display unit 28. Subsequently, in step S1916, the system control unit 50 executes the processing according to the narrowing-down reproduction mode. With the narrowing-down reproduction mode, upon a particular group being specified, reproduction or the like of image data can be performed in a narrowing-down state within the group thereof. This narrowing-down reproduction processing will be described later with reference to FIG. 15. Upon the narrowing-down reproduction processing being completed, the processing proceeds to step S1920, where the system control unit 50 stores the jump key in the nonvolatile memory 56, and ends the jump mode. The jump key stored in step S1920 becomes the jump key to be determined in step S1901 when changing to the jump mode next time.

In a case wherein the operating input detected in step S1907 has been operations for instructing the end of the jump mode, the processing proceeds to step S1918 from step S1917. Examples of the operations for ending the jump mode include operations for pressing the MENU button. In the case of such operations being performed, in step S1918 the system control unit 50 redraws the image on the entirety of the image display unit 28. Subsequently, in step S1920, the system control unit 50 stores the jump key in the nonvolatile memory 56, and ends the jump mode.

Also, in a case wherein the operating input detected in step S1907 has been power-off operations by the power supply switch 72, the processing proceeds to step S1920 from step S1919. That is to say, in a case wherein determination is made that the power-off operations have been performed, the system control unit 50 records the jump key currently selected, and ends this jump mode.

In a case wherein the operating input detected in step S1907 has not corresponded to none of the above operations, the system control unit 50 executes no processing, and the processing returns to step S1907, where the system control unit 50 enters a state waiting for operating input from the user.

### Narrowing-Down Reproduction Mode Processing

Description will be made regarding the narrowing-down reproduction mode in step S1916 shown in FIG. 13 using an example wherein classification information is taken as a narrowing-down condition. With the narrowing-down reproduction mode using classification information, of the image data recorded in the recording medium 200, only the image classified into certain classification information, i.e., only the image belonging to a certain group is taken as a reproduction target. Subsequently, the same operations as those in the ordinary reproduction mode, such as deletion, protection, rotation of an image, multiple image display, and so forth, can be performed regarding the image to be reproduced. Note that examples of the classification include, as described above, person, scenery, event, categories 1, 2, and 3, and for work. FIG. 15 is the flowchart of the narrowing-down reproduction mode processing.

When entering the narrowing-down reproduction mode, first, in step S2301, the system control unit 50 displays a guidance showing a method for escaping form the narrowing-down reproduction mode on the screen. This guidance shows that a predetermined operating member, e.g., the upper button of the operating unit 70 is operated, thereby returning to the entire image reproduction.

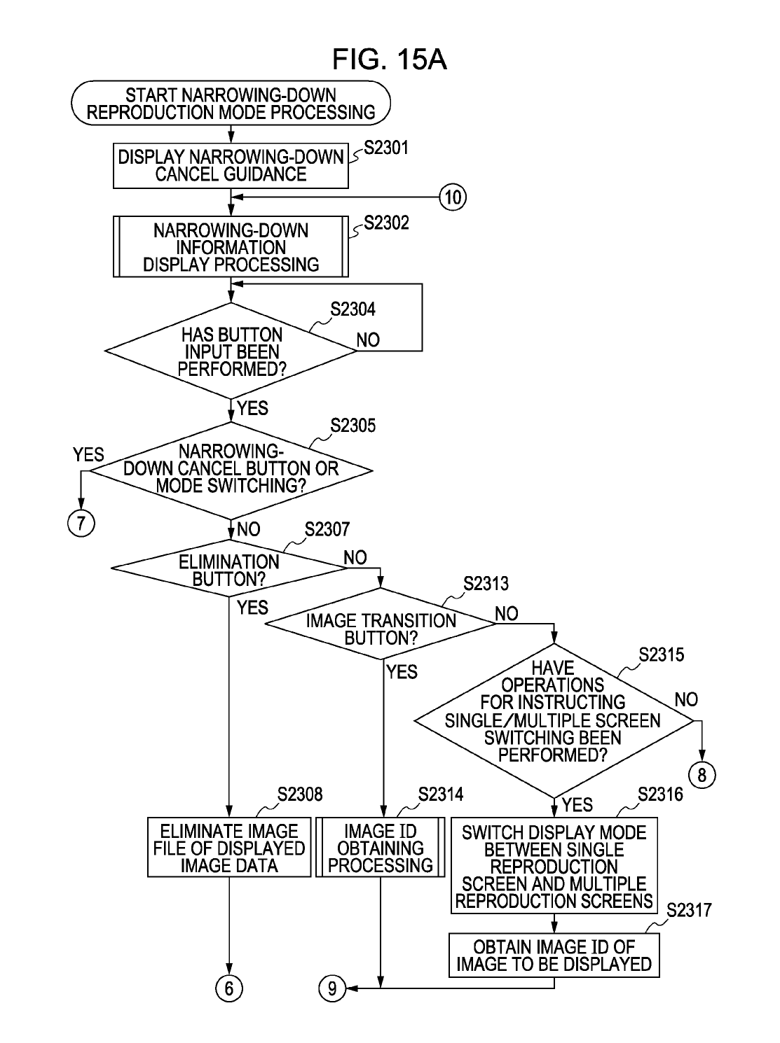

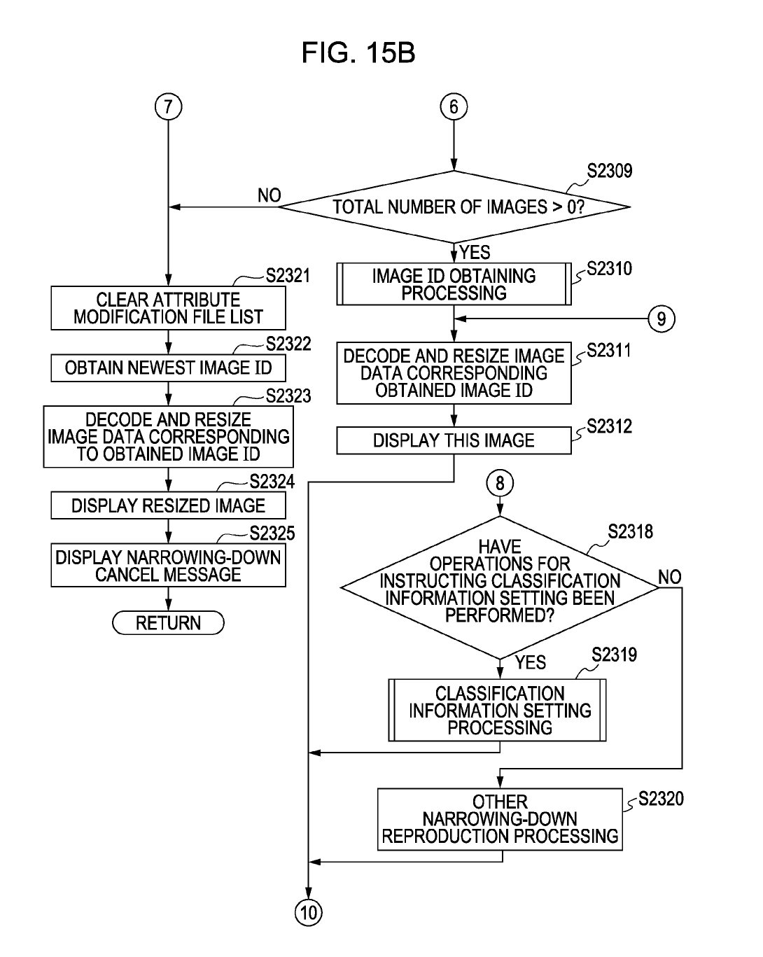

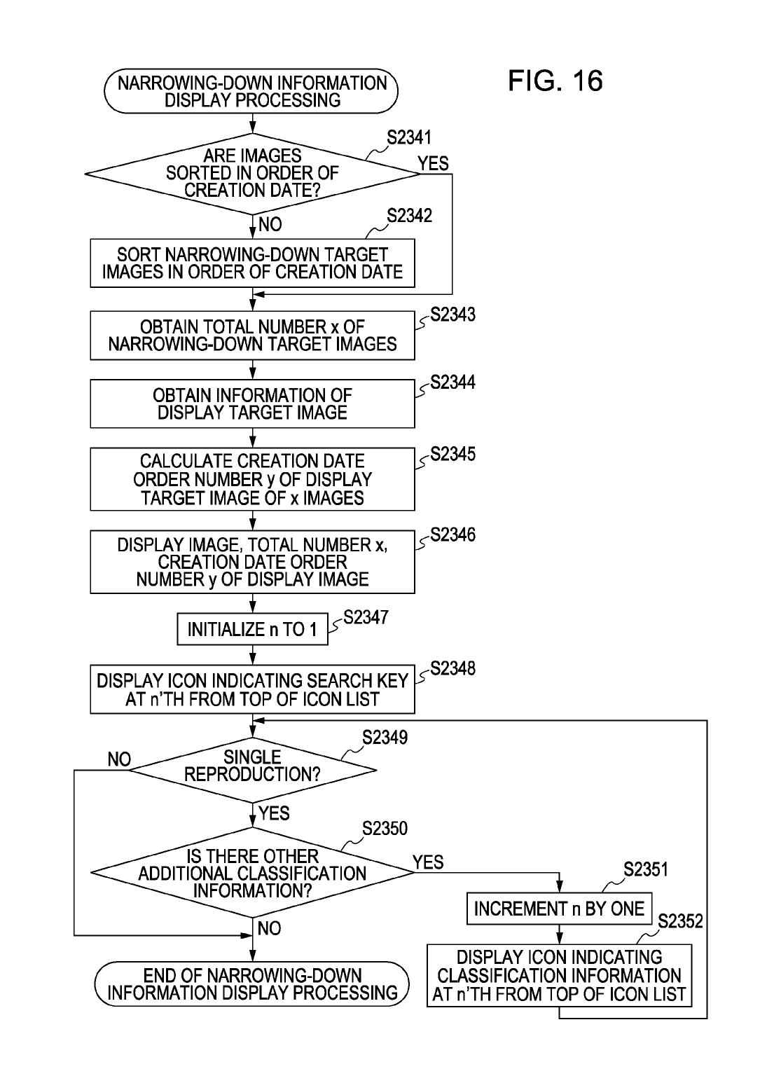

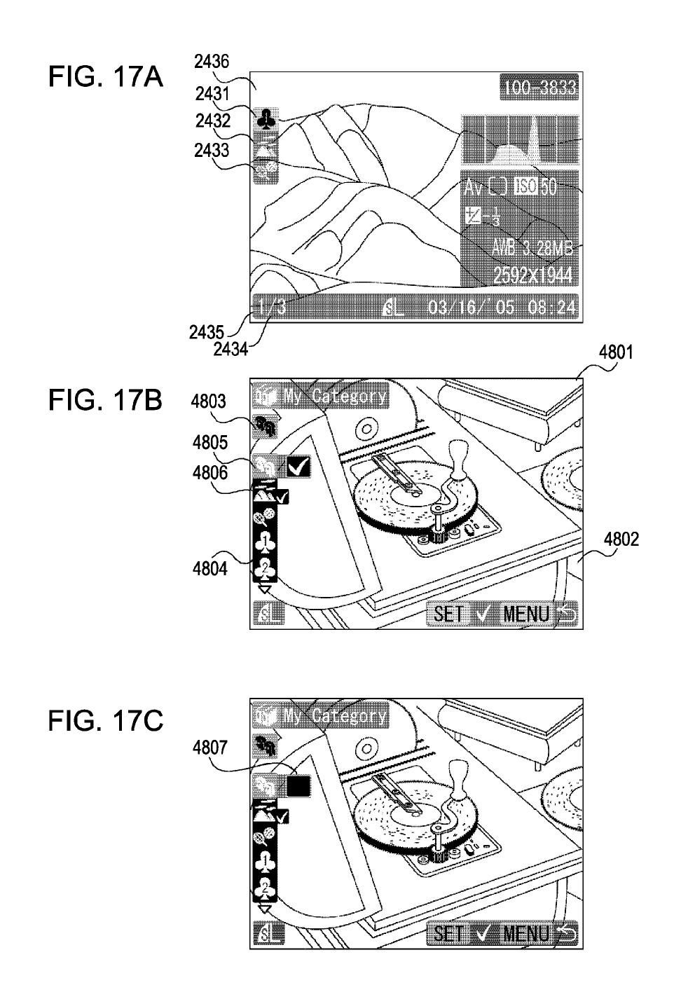

Next, in step S2302, the system control unit 50 executes narrowing information display processing for displaying an icon or the like representing a narrowing-down state, and performs display such as shown in FIG. 17A. The display example in FIG. 17A and the details of the narrowing-down information display processing will be described later with reference to FIG. 16.

Step S2304 is a state waiting for operating input from the user. Upon operating input from the user being detected, the processing proceeds to step S2305.

In step S2305, the system control unit 50 determines whether the operating input detected in step S2304 has been instructions for canceling narrowing-down reproduction or mode changeover. In a case wherein determination is made that the operating input was instructions for canceling narrowing-down reproduction or mode changeover, the processing proceeds to step S2321, where the system control unit 50 clears an attribute modified file list described later with reference to FIG. 18. Subsequently, the processing proceeds to step S2322, where the system control unit 50 obtains the youngest ID of the IDs of the image data stored in the recording medium 200. In step S2323, the system control unit 50 decodes and resizes the image data of the youngest ID, and in step S2324 displays the image data thereof on the image display unit 28. Subsequently, in step S2325, the system control 50 displays a narrowing-down cancel message, and ends the narrowing-down reproduction mode processing. The button for narrowing-down cancel instructions may be the same as the button for entering the jump mode for performing narrowing down. Also, the mode changeover is performed in a case wherein there is a need to leave the reproduction mode, or the like. At this time, with regard to the operation escaping from the reproduction mode, whether or not narrowing down is automatically cancelled with the setting can also be set.

On the other hand, in step S2307, the system control unit 50 determines whether or not the operating input detected in step S2304 has been deletion instructions (delete button). In the case of the deletion instructions (delete button), the processing proceeds to step S2308. In step S2308, the system control unit 50 deletes the image file of the image data currently displayed on the image display unit 28. Upon the image file being deleted, the processing proceeds to step S2309. In step S2309, the system control unit 50 determines whether or not an image which can be reproduced in the current narrowing-down condition remains. This may be, for example, whether or not the image having the current narrowing-down attribute remains, or whether or not the image which was a reproduction target at the time of start of narrowing down remains. In a case wherein no image which can be reproduced remains, the processing proceeds to step S2321, where the system control unit 50 performs processing for ending the narrowing-down reproduction mode processing. On the other hand, in a case wherein the image which can be reproduced remains in step S2309, the processing proceeds to step S2310, where the system control unit 50 obtains the ID of image data to be displayed next. This image ID obtaining processing will be described later with reference to FIG. 19. Subsequently, in step S2311, the system control unit 50 decodes and resizes the image data thereof, in step S2312 displays the image data thereof on the image display unit 28. Subsequently, following the image data thereof being displayed on the screen, the processing returns to step S2302, where the system control unit 50 executes the narrowing-down information display processing.

Also, in step S2313, the system control unit 50 determines whether or not the operating input detected in step S2304 has been image feeding instructions for instructing image transition. In a case wherein the operating input was the image feeding instructions (in the case of the operating input of the left or right button in this example), the processing proceeds to step S2314. In step S2314, in a case wherein the pressed button has been the left button, with the image data currently being displayed as reference, the system control unit 50 obtains the image ID one step back to be displayed in the current narrowing-down condition, and in a case wherein the pressed button has been the right button, obtains the image ID one step forward. This image ID obtaining processing will be described later with reference to FIG. 19. Following obtaining the image ID, in step S2311 the system control unit 50 decodes and resizes the image to be processed, and in step S2312 displays this on the screen. Subsequently, the processing returns to step S2302, where the system control unit 50 executes the narrowing-down information display processing.

Also, in step S2315, the system control unit 50 determines whether or not the operating input detected in step S2304 has been instructions for single/multiple screen changeover. In a case wherein the operating input was instructions for single/multiple screen changeover, the processing proceeds to step S2316. In step S2316, the system control unit 50 switches the display mode to a multiple reproduction screen when the current display on the image display unit 28 is a single reproduction screen, and switches the display mode to a single reproduction screen when the current display on the image display unit 28 is a multiple reproduction screen. Subsequently, in step S2317, the system control unit 50 obtains the ID of an image to be displayed on the image display unit 28. Subsequently, in step S2311, the system control unit 50 decodes and resizes the image data corresponding to the ID obtained in step S2317. Subsequently, in step S2312, the system control unit 50 displays the image data processed in step S2311 on the image display unit 28. Subsequently, the processing returns to step S2302, where the system control unit 50 executes the narrowing-down information display processing.

Also, in step S2318, the system control unit 50 determines whether or not the operating input detected in step S2304 has been input for instructing classification information setting by the operations of an attribute modification button. In a case wherein the operating input was input for instructing classification information setting, the processing proceeds to step S2319, where the system control unit 50 performs the classification setting processing described above with reference to FIG. 10. Note that with the classification information setting screen mentioned here, the current state is in the middle of the narrowing-down reproduction processing, so unlike the display shown in FIG. 12, the system control unit 50 performs display such as shown in FIG. 17B or 17C. The display shown in FIGS. 17B and 17C will be described later. Upon the classification information setting processing being completed in step S2319, the processing returns to step S2302, where the system control unit 50 executes the narrowing-down information display processing. Note that at the time of end of the classification information setting processing in step S2319, the system control unit 50 may cancel the narrowing-down reproduction to leave the present processing.

In a case wherein the operating input detected in step S2304 has not correspond to none of the above, in step S2320 the system control unit 50 executes other narrowing-down reproduction processing corresponding to the operating input. Following the end of the processing, the processing returns to step S2302, where the system control unit 50 executes the narrowing-down information display processing.

Note that even during narrowing-down reproduction various operations can be performed. For example, during narrowing-down reproduction, the system control unit 50 may perform processing involving narrowing down using classification information separate from the classification information to be narrowed down currently. In this case, the system control unit 50 cancels the current narrowing-down reproduction mode automatically. Canceling the current narrowing-down reproduction mode prevents the user from becoming confused regarding with which attribute information the user is narrowing down. Note that an arrangement may be made wherein in a case wherein the processing involving narrowing down thereof is not processing for performing image reproduction but protect processing or deletion or the like of an image file, the system control unit 50 maintains the current narrowing-down reproduction, and in a case wherein the processing involving narrowing down thereof is processing for performing reproduction such as a slide show, the system control unit 50 cancels the narrowing-down reproduction.

### Narrowing-Down Information Display Processing

The narrowing-down information display processing in step S2302 shown in FIG. 15 will be described. As described above, with the jump mode, upon the operating input for instructing narrowing-down reproduction using classification information being detected from the operating unit 70, the system control unit 50 starts narrowing-down reproduction processing for reproducing only the image file to which the classification information set by the user is added. In order to inform the user that narrowing-down reproduction is being performed at the time of start of the narrowing-down reproduction processing or at the time of image feeding during narrowing-down reproduction, there is a need to perform information display specific to narrowing-down reproduction as to the display image. In the above-mentioned step S2302, such narrowing-down information display processing is executed, and hereafter, description will be made in detail regarding this processing. FIG. 16 is a flowchart illustrating the narrowing-down information display processing.

Upon the narrowing-down information display processing being started, first, in step S2341, the system control unit 50 determines whether or not the image files narrowed down have been sorted in order of creation date. In a case wherein determination is made that the image files have not been sorted, in step S2342, the system control unit 50 sorts the image files narrowed down in order of creation date. Note that the sorting according to the present embodiment is performed in ascending order of creation date, i.e., from old date to new date, but may be performed in descending order of creation date, i.e., from new date to old date. Also, this does not necessarily have to be in order of date as long as the image files are sorted in accordance with a certain rule. For example, the image files may be sorted with file numbers.

Next, in step S2343, the system control unit 50 obtains the total number of images x of the image files narrowed down. The total number of images x of the image files narrowed down is equivalent to the number of images that can be fed at the time of narrowing down, and with the present embodiment, this becomes the number of images having the attribute of the narrowing-down condition at the time of narrowing-down reproduction being started. This is because an image of which the attribute was modified during narrowing-down reproduction, which has not matched with the narrowing-down condition, also becomes a reproduction target during the narrowing-down reproduction being currently performed. Note that with an image processing apparatus for reproducing only the image which matches with the narrowing-down condition at the time of narrowing-down reproduction, the total number of images x becomes the total number of images having the attribute of the narrowing-down condition at the time thereof.

Subsequently, in step S2344, the system control unit 50 obtains the image information of an image file to be displayed on the image display unit 28. At this time, the image files narrowed down have been sorted in order of creation date. Accordingly, in the subsequent step S2345, the system control unit 50 calculates whether the image file is an image created at what number of the image files narrowed down (creation date order number y) based on the creation date of the image file to be displayed. Thus, the system control unit 50 obtains the total number of images x of the image file narrowed down, information of an image to be displayed, and creation date order number y of an image to be displayed. In step S2346, the system control unit 50 displays the total number of images x of the image file narrowed down, information of an image to be displayed, and creation date order number y of an image to be displayed, on the image display unit 28. Subsequently, in step S2347, the system control unit 50 initializes a variable n representing the display position of an icon indicating classification information to 1. Subsequently, in step S2348, the system control unit 50 displays an icon indicating the search key on the n′th (uppermost) of the icon list.

Subsequently, in step S2349, the system control unit 50 determines whether or not reproduction display has been set to either single reproduction or multiple reproduction. In a case wherein determination is made that reproduction display has been set to multiple reproduction display, the present processing ends. This is for simplifying information display.

On the other hand, in a case wherein determination is made that reproduction display has been set to single reproduction display, the processing proceeds to step S2350. In step S2350, the system control unit 50 determines whether or not there is classification information added to the display image 2436 other than the classification information serving as the search key. In the case of other classification information being added thereto, in step S2351 the system control unit 50 increments the variable n representing the display position of an icon. Subsequently, in step S2352, the system control unit 50 displays the icon indicating the classification information thereof at the n′th in the icon list.

The system control unit 50 repeats the processing in steps S2350 through S2352 until all of the icons indicating the classification information added to the display image 2436 are displayed on the image display unit 28, and upon all of the icons being displayed, the present processing ends.

An example of a screen displayed as a result of the narrowing-down information display processing is illustrated in FIG. 17A. In FIG. 17A, let us say that the classification information of “scenery” and “event” has been added to the display image 2436 in addition to the classification of “category 1”, and narrowing-down reproduction is being performed with “category 1” as the searched key. According to the processing in step S2346, the total number of images x of the files narrowed down (2434), and creation date order number y of the display image (2435) are each displayed at the lower left of the screen. In this example, according to the total number of images x of the files narrowed down (2434), and creation date order number y of the display image (2435), display as “⅓” is generated. That is to say, the number of images to which the classification information of “category 1” is added is 3 images in total, and the display image 2436 is the oldest image (1st image) thereof. According to the processing in step S2348, the icon 2431 of “category 1” is displayed on the top of the left of the screen, whereby the user can recognize that the classification information currently narrowed down (search key) is “category 1”. Note that the icon 2431 may be displayed on any place as long as this place is a place where the user can recognize at a glance the classification information currently narrowed down, and accordingly, the display position may be the lowest portion of the screen. Also, the icon 2431 indicating the classification information currently narrowed down may be displayed with a different color or different size to differentiate the icon 2431 from the icons 2432 and 2433 indicating other classification information. Also, it is found that according to the processing in step S2352, the icon 2432 indicating the classification information of “scenery” and the icon 2433 indicating the classification information of “event” are displayed, and such classification information is added to the image 2436 being displayed.

Note that, with the present embodiment, the classification information added to the image being displayed is displayed with an icon, but is not restricted to this as long as the user can recognize the classification information added to the image being displayed, e.g., the name of classification information may be displayed directly.

Also, display such as shown in FIG. 17A performed by the narrowing-down information display processing has been described on the premise of narrowing-down reproduction using the search key, but the present display processing may be performed during the jump mode before narrowing down, for example. In this case, the icon indicating the search key is displayed on the top during the jump mode, so the user can recognize at a glance which key to specify, and then when entering narrowing-down reproduction as well, the position of the icon does not change, so the user can continue operations smoothly.

### Classification Information Setting Screen at the Time of Narrowing-Down Reproduction

Description will be made regarding the classification information setting screen in step S2319 during the narrowing-down reproduction mode processing described above with reference to FIG. 15. FIGS. 17B and 17C are screen display examples in the case of performing the classification information setting processing during the narrowing-down reproduction mode processing.

In FIG. 17B, a classification information setting screen 4801 indicates the entirety of the classification information setting screen at the time of narrowing-down reproduction. The classification information stored in a correlated manner with the image data currently being displayed can be modified by the operations from the classification information setting screen 4801. An icon 4803 is an icon indicating the narrowing-down condition of the current screen, and the present embodiment represents that narrowing-down reproduction is performed with the classification information of “person”. List display 4804 is list display of settable classification information. A check mark is indicated on the classification information added to the image data being displayed. In FIG. 17B, a check mark is displayed on the classification display 4805 of “person” and the classification display 4806 of “scenery”. Accordingly, it can be found that the classification information of “person” and “scenery” is added to the image data 4802 displayed on the classification information setting screen 4801. Also, the classification display 4805 is classification information currently being modified, and has a background color which has been changed such that the user can recognize that the cursor is pointed thereto. Further, the check mark thereof is displayed greater than those of the other classification. The user presses the SET button included in the operating unit 70 in this state, thereby turning on/off the classification information thereof. Upon the user performing the above-mentioned operations in a state wherein the classification information to be modified is not added to the image data being displayed, the classification information is added to the image data by pressing the SET button. On the other hand, upon the user performing the above-mentioned operations in a state wherein the classification information to be modified is added to the image data being displayed, the classification information is deleted from the image data by pressing the SET button.

Upon the user performing operations for deleting the classification information of “person” in accordance with the above-mentioned operations, the display such as shown in FIG. 17B is changed to display such as shown in FIG. 17C. FIG. 17C is a display example of the classification information setting screen of an image from which the classification information of “person” has been removed during narrowing-down reproduction with “person”. It can be found that the icon indicating the narrowing-down condition of the current screen is “person”, and no check mark is indicated on the classification display 4807, and accordingly, the image data 4802 is in a state wherein the classification information of “person” has been removed regardless of during narrowing-down reproduction with “person”. Display similar to this is also displayed when the image data 4802 is displayed again at the classification information setting without canceling the narrowing-down reproduction, following classification information being actually written out by image feeding or classification information setting end operations. This will be described in detail with later-described image ID obtaining processing.

Thus, in a case wherein the user performs the operations for removing the classification information of the narrowing-down condition as to the image data during narrowing-down reproduction as well, the narrowing-down condition and the classification information added to the reproduction data are displayed. Thus, the user can determine whether or not the image is matched to the current narrowing-down.

### Attribute Modified File Management Processing

Description will be made regarding the attribute modified file management processing executed in step S2524 of the classification information writing processing described with reference to FIG. 11. The attribute modified file management processing is processing for managing an image which had attribute information matching the narrowing-down condition at the time of start of the narrowing-down reproduction processing, but has had no attribute matching to the narrowing-down condition since the attribute information was modified during narrowing-down reproduction processing. FIG. 18 is a flowchart illustrating the attribute modified file management processing.

Upon the attribute modified file management processing being started, first, in step S4601, the system control unit 50 determines whether or not narrowing-down reproduction is being performed. In a case wherein narrowing-down reproduction is not being performed, in step S4604 the system control unit 50 clears the attribute modified file list, and escapes this processing. In a case wherein determination is made that narrowing-down reproduction is being performed, the processing proceeds to step S4602.

In step S4602, the system control unit 50 determines whether or not an image file of which the classification information has been changed is identical to the current narrowing-down condition after modification of the classification information. In a case wherein determination is made that the image file is not identical to the current narrowing-down condition, in step S4605 the system control unit 50 stores information identifying the image file of which the classification information such as a file path, ID, address, or the like has been modified in the attribute modified file list. On the other hand, the image file after modification of classification information is identical to the narrowing-down condition, the processing proceeds to step S4603.

In step S4603, the system control unit 50 determines whether or not the information identifying the image file of which the classification information has been modified has been stored in the attribute modified file list. In a case wherein the information has been stored in the attribute modified file list, the processing proceeds to step S4606, where the system control unit 50 deletes the information identifying the image file of which the classification information has been modified from the attribute modified file list.

Thus, the information identifying the image file of which classification information has been modified, stored in the attribute modified file management processing (attribute modified image is stored), is employed for image selection at the image ID obtaining processing described with reference to FIG. 19.

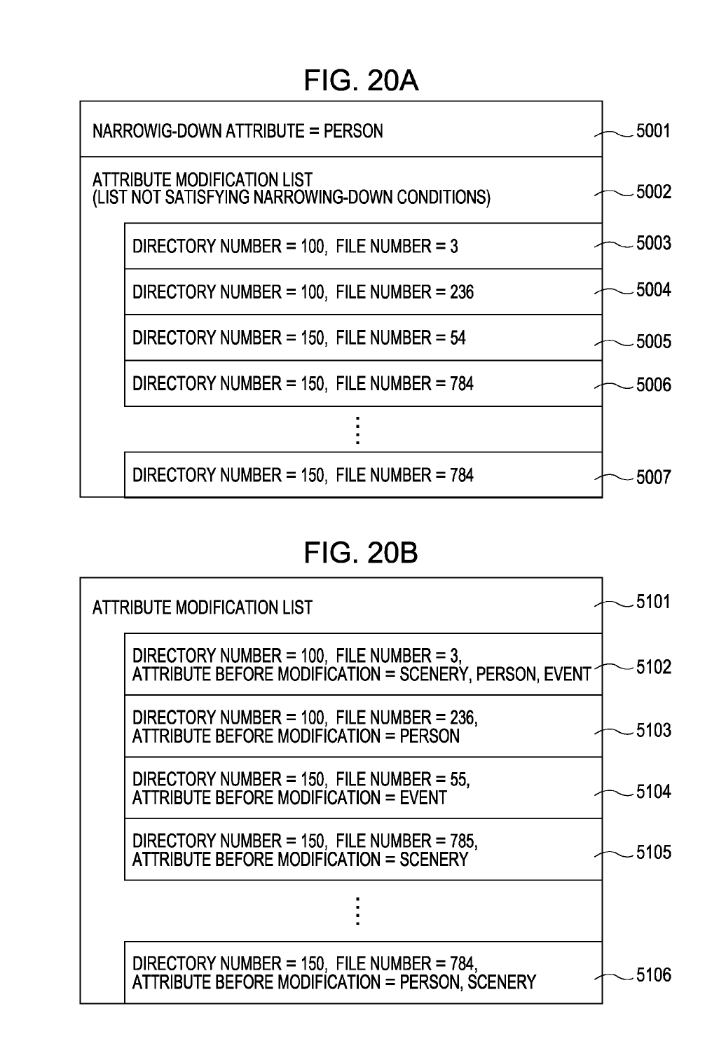

FIG. 20A illustrates an example of the attribute modified file list managed at the attribute modified file management processing shown in FIG. 18. FIG. 20A lists only the files excluded from the narrowing-down condition. In FIG. 20A, reference numeral 5001 denotes a portion storing the current narrowing-down condition, and reference numerals 5002 through 5007 denote portions storing information for identifying only files excluded from the narrowing-down condition with attribute modification in a narrowing-down state, each of which is made up of a directory number and file number. According to this list, only the files excluded from the narrowing-down condition are stored, whereby the use quantity of the storage area of the system memory 52 for the list can be further reduced.

Note that with the attribute modified file management processing shown in FIG. 18, registration to the attribute modified file list is restricted to the files excluded from the narrowing-down reproduction condition, but may be restricted simply to the images of which the attributes have been modified. In this case, the attribute modified file list is such as shown in FIG. 20B. FIG. 20B is an example of an attribute modification list 5101 wherein the files of which the attributes have been modified in a narrowing-down state are listed evenly regardless of the narrowing-down condition. In the attribute modification list 5101, reference numerals 5102 through 5106 denote portions storing a directory number and file number as the identification information of a file, storing the attributes before attribute modification. According to this list, the state before attribute modification is stored, so for example, cancellation of attribute modification, and attribute display immediately before attribute modification can be performed.

### Image ID Obtaining Processing

Description will be made regarding the image ID obtaining processing executed in step S2514 of the classification information setting processing described with reference to FIG. 10, and executed in step S2314 of the narrowing-down reproduction mode processing described with reference to FIG. 15. The image ID obtaining processing is processing wherein the next or previous image identical to the current narrowing-down condition is compared with the images stored in the above-mentioned attribute modified file list to obtain the ID of an image to be displayed. FIG. 19 illustrates the flowchart of the image ID obtaining processing.

In step S4701, the system control unit 50 obtains the ID of the next (or previous) image with the current narrowing-down condition. With this processing, the file headers on the recording medium may be searched sequentially, or the next (or previous) image identical to the narrowing-down condition may be searched on the search management file described with reference to FIG. 8.

In a case wherein the next (or previous) image has been identified in step S4701, in step S4702 the system control unit 50 determines whether or not the image positioned between the image being currently reproduced, and the image searched in step S4701 exists on the attribute modified list described with reference to FIG. 20. In a case wherein determination is made that there is no relevant file, the system control unit 50 regards the image searched in step S4701 as the next (or previous) image to create an ID (step S4704), and leaves the processing. On the other hand, in a case wherein the image has been found in step S4702, the system control unit 50 regards the next (or previous) image of the image being currently reproduced as the next (or previous) image to create an ID on the found attribute modified file list (steps S4703 and S4704), and leaves the processing.

According to the present processing, the system control unit 50 obtains the ID of an image such as the image data 4802 in a state of FIG. 17C, i.e., the ID of an image of which the classification information of “person” which had been added at first has been excluded by the classification information processing during narrowing-down reproduction with “person”, as a reproduction target. The display screen at this time becomes the display of FIG. 17C, for example, when the ID of the image data 4802 is obtained in step S2514 (image ID obtaining processing) of the classification information setting processing described above with reference to FIG. 10 during narrowing-down reproduction. An image stored in the attribute modified file list is an image of which the classification information which is the narrowing-down condition has been already deleted from the file header, but can be identified as an image excluded from the narrowing-down condition during narrowing-down reproduction by the display of the classification display 4807 shown in FIG. 17C. Note that instead of the display such as the classification display 4807 shown in FIG. 17C, a guidance, icon display, or the like indicating an image excluded from the narrowing-down condition during narrowing-down reproduction may be displayed in an enhanced manner.

According to such processing, an image of which the classification information has been modified during narrowing-down reproduction and excluded from the narrowing-down condition can be taken as a browsing target. Also, the user can confirm whether or not there has been an image excluded from narrowing-down condition during narrowing-down reproduction. Also, the user can confirm whether or not the classification information of the narrowing-down condition has been added to the image being browsed at first when starting narrowing-down reproduction, and also the classification information of the narrowing-down condition has been excluded during narrowing-down reproduction. Thus, with the classification information setting screen or the like during narrowing-down reproduction, the user can readily set classification information again without confusion.

Also, with the present embodiment, for example, all of the files identical to the narrowing-down condition are not listed at the time of start of the narrowing-down reproduction processing, an image identical to the narrowing-down condition is searched successively at the time of performing image feeding during narrowing-down reproduction (step S2314 in FIG. 15). Therefore, an arrangement for employing an image of which the classification information has been modified during narrowing-down reproduction as a browsing target can be changed to an arrangement wherein only the information determining an image excluded from the narrowing-down condition is stored. Thus, an image of which the classification information has been modified during narrowing-down reproduction can be employed as a browsing target with little memory usage, and accordingly, the present invention can be applied to a restricted source such as a digital camera.

Note that a narrowing-down example using classification information has been described here, but the narrowing condition is not restricted to this, and as long as the attribute information of an image can be employed as the narrowing-down condition, and can be modified during narrowing-down reproduction, the present invention can be applied to such attribute information.

The present invention has been described so far using the digital camera, but the application of the present invention is not restricted to this, and rather the present invention can be applied to a device capable of reproducing an image, such as a cellular phone, mobile terminal, and so forth.

The present invention also encompasses a case wherein a software program for realizing the functions of the above-mentioned embodiments is supplied to a system or device including a computer capable of executing the program from a recording medium directly, or using cable/wireless communication, thereby executing the program thereof.

Accordingly, program code itself for realizing the function processing of the present invention at a computer which is supplied and installed to the computer also realizes the present invention. That is to say, the present invention also encompasses a computer program itself for realizing the function processing of the present invention.

In this case, the computer program may be provided in any form such as object code, a program executed by an interpreter, script data supplied to the OS (Operating System), or the like, as long as this has a program function.

Examples of a recording medium for supplying the program include magnetic recording media such as a flexible disk, hard disk, magnetic tape, or the like, optical/magneto-optical recording media such as MO, CD-ROM, CD-R, CD-RW, DVD-ROM, DVD-R, DVD-RW, and so forth, and nonvolatile semiconductor memory.

As for a program supply method employing cable/wireless communication, a method can be conceived wherein the computer program itself making up the present invention, or program data files, is/are stored in a server on a computer network, and the program data file is downloaded to a client computer which has issued a connection request.

The program data file mentioned here includes a file including the compressed computer program making up the present invention, and automatic install function, and so forth. In this case, an arrangement may be made wherein the program data file is divided into multiple segment files, and the segment files thereof are stored at different servers. That is to say, the present invention also encompasses a server device for allowing multiple users to download the program data file for realizing the function processing of the present invention at a computer.

Also, a method can be conceived wherein the program for realizing the functions of the above-mentioned embodiments is encrypted, stored in a recording medium, and distributed to users, and key information for decrypting encryption is supplied to a user satisfying predetermined conditions by being downloaded through a network. Using the key information enables the encrypted program to be executed, and installed in a computer, whereby the present invention can be realized.

The functions of the above-mentioned embodiments are realized by the computer executing the supplied program code. Also, in a case wherein the functions of the above-mentioned embodiments are realized by the program code collaborating with the OS or other application software or the like operating on the computer as well, such program code is encompassed in the embodiments of the present invention.

Further, the present invention also encompasses a case wherein the supplied program code is stored in memory included in a function expansion board of the computer, or a function expansion unit connected to the computer. Also, it goes without saying that the present invention also encompasses a case wherein a CPU or the like included in the function expansion board or function expansion unit performs a part or all of the actual processing based on the instructions of the program code, thereby realizing the functions of the above-mentioned embodiments by the processing thereof.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2007-208731 filed Aug. 10, 2007, which is hereby incorporated by reference herein in its entirety.

What is claimed is:

1. An image management apparatus comprising:
a narrowing-down reproduction unit configured to reproduce an image having particular attribute information;
an attribute modification unit configured to modify attribute information of the image reproduced by said narrowing-down reproduction unit;
an attribute modified image information storing unit configured to store information indicating the image which no longer contains the particular attribute information because of the modification performed on the attribute information by the attribute modification unit; and
a control unit configured to perform control so as to regard the image indicated with the information stored in said attribute modified image information storing unit as a target image to be reproduced by said narrowing-down reproduction unit, by referencing the information stored in said attribute modified image information storing unit, from the time of modifying the attribute information with said attribute modification unit until reproduction by said narrowing-down reproduction unit is cancelled.

2. The image management apparatus according to claim 1, wherein said narrowing-down reproduction unit successively searches an image having said particular attribute information at the time of switching an image to be reproduced.

3. The image management apparatus according to claim 1, wherein said attribute modified image information storing unit does not store information other than the information indicating the image which no longer contains the particular attribute information because of the modification performed on the attribute information by the attribute modification unit.

4. The image management apparatus according to claim 1, wherein said attribute modified image information storing unit does not store information other than the information indicating the image which no longer contains the particular attribute information because of the modification performed on the attribute information by the attribute modification unit, and information indicating said particular attribute information.

5. The image management apparatus according to claim 1, wherein said attribute modified image information storing unit further stores information indicating the image of which the attribute information has been modified by said attribute modification unit, and the attribute information that has been modified.

6. The image management apparatus according to claim 5, wherein the attribute information of the image is determined before the modification of the attribute information based on the information stored in said attribute modified image information storing unit.

7. The image management apparatus according to claim 1, further comprising:
a display control unit configured to perform control so as to distinguishably display the image which no longer contains the particular attribute information because of the modification performed on the attribute information by the attribute modification unit, at the time of reproduction by said narrowing-down reproduction unit.

8. An image management method comprising the steps of:
reproducing an image having particular attribute information;
modifying attribute information of the image reproduced in said reproducing;
storing information indicating the image which no longer contains the particular attribute information because of the modification performed on the attribute information; and
performing control so as to regard the image indicated with the information stored in said storing, as a target image to be reproduced in said reproducing, by referencing the information stored in said storing, from the time of modifying the attribute information in said modifying until reproduction in said reproducing is cancelled.

9. A computer-readable recording medium storing a program causing a computer to function as:
a narrowing-down reproduction unit configured to reproduce an image having particular attribute information;
an attribute modification unit configured to modify attribute information of the image reproduced by said narrowing-down reproduction unit;
an attribute modified image information storing unit configured to store information indicating the image which no longer contains the particular attribute information because of the modification performed on the attribute information by the attribute modification unit; and
a control unit configured to perform control so as to regard the image indicated with the information stored in said attribute modified image information storing unit as a target image to be reproduced by said narrowing-down reproduction unit, by referencing the information stored in said attribute modified image information storing unit, from the time of modifying the attribute information by said attribute modification unit until reproduction by said narrowing-down reproduction unit is cancelled.

10. An image capturing apparatus comprising:
an image capturing unit configured to image-capture a subject;
an adding unit configured to add attribute information to an image captured by said image capturing unit;
a recording control unit configured to perform control so as to record the image captured by said image capturing unit in a recording medium;
a narrowing-down reproduction unit configured to reproduce an image having particular attribute information, of images recorded in said recording medium;
an attribute modification unit configured to modify the attribute information of the image reproduced by said narrowing-down reproduction unit; and
a control unit configured to perform control so as to regard the image which no longer contains the particular attribute information because of the modification performed on the attribute information by the attribute modification unit, as a target image to be reproduced by said narrowing-down reproduction unit, from the time of modifying the attribute information by said attribute modification unit until reproduction by said narrowing-down reproduction unit is cancelled.

11. An image capturing apparatus control method comprising the steps of:
image-capturing a subject;
adding attribute information to an image captured in said image-capturing;
performing control so as to record the image captured in said image-capturing in a recording medium;
reproducing an image having particular attribute information, of images recorded in said recording medium;
modifying the attribute information of the image reproduced in said reproducing; and
performing control so as to regard the image which no longer contains the particular attribute information because of the modification performed on the attribute information, as a target image to be reproduced in said reproducing, from the time of modifying the attribute information in said modifying until reproduction in said reproducing is cancelled.

12. A computer-readable recording medium recording a program causing a computer to function as:
an image capturing unit configured to image-capture a subject;
an adding unit configured to add attribute information to an image captured by said image capturing unit;
a recording control unit configured to perform control so as to record the image captured by said image capturing unit in a recording medium;
a narrowing-down reproduction unit configured to reproduce an image having particular attribute information, of images recorded in said recording medium;
an attribute modification unit configured to modify the attribute information of the image reproduced by said narrowing-down reproduction unit; and
a control unit configured to perform control so as to regard the image which no longer contains the particular attribute information because of the modification performed on the attribute information by the attribute modification unit, as a target image to be reproduced by said narrowing-down reproduction unit from the time of modifying the attribute information by said attribute modification unit until reproduction by said narrowing-down reproduction unit is cancelled.
